(19) United States
(12) Patent Application Publication
(10) Pub. No.: US 2025/0268777 A1
(43) Pub. Date: Aug. 28, 2025

(54) OPTIMIZED KNEE EXOSKELETON WITH TUNABLE COMPLIANCE FOR REHABILITATION AND ASSISTANCE

(71) Applicant: Khalifa University of Science And Technology, Abu Dhabi (AE)

(72) Inventors: Ahmad Adnan Aljarah, Abu Dhabi (AE); Irfan Hussain, Abu Dhabi (AE); Laith AbuAssi, Abu Dhabi (AE); Yahya Zweiri, Abu Dhabi (AE)

(21) Appl. No.: 19/063,632

(22) Filed: Feb. 26, 2025

Related U.S. Application Data
(60) Provisional application No. 63/557,819, filed on Feb. 26, 2024.

(51) Int. Cl. A61H 1/02; A61H 3/00

(52) U.S. Cl. CPC A61H 1/024; A61H 3/00; A61H 2201/0107; A61H 2201/1215; A61H 2201/14; A61H 2201/164; A61H 2201/1676; A61H 2230/625

(57) ABSTRACT

Embodiments of the present technology may include an exoskeleton system for modulating joint stiffness to mimic a stiffness change trajectory of a corresponding human joint. The exoskeleton system can include a plurality of modules. Additionally, the exoskeleton system can include at least one joint. The at least one joint can connect a thigh module to a shank module of the plurality of modules. The exoskeleton system can further include a variable stiffness actuator (VSA) system. The VSA system can drive the plurality of modules. Additionally, the VSA system can be coupled with the thigh module and the shank module.

### CROSS-REFERENCES TO RELATED APPLICATIONS

This application claims the benefit of U.S. Provisional Patent Application No. 63/557,819, filed Feb. 26, 2024, the entire contents of which are hereby incorporated by reference for all purposes in its entirety.

### BACKGROUND OF THE INVENTION

People who have suffered a stroke can experience trouble performing mobility tasks. Lower limb joints of post-stroke hemiplegic patients can be affected by the stroke. Knees can be particularly affected. A condition known as stiff-knee gait can occur. Stiff-knee gait can involve a dropping off of a peak knee flexion in a swing phase of a gait. Rehabilitation therapy may be most effective if administered soon after an occurrence of a stroke. Additionally, intensive therapy and task-based exercises may contribute significantly to partial or full motor recovery. In conventional rehabilitation therapies, patients can perform repetitive limb movements with assistance from a physical therapist. This conventional approach can require extensive and consistent training periods for patients, as well as intensive labor for therapists. Assessment of manual therapy can lack proper quantification, since the assessment can depend highly on subjective scales and human assessment/reports can be prone to error.

### BRIEF SUMMARY OF THE INVENTION

A compliant exoskeleton design can modulate a joint stiffness to mimic a stiffness change trajectory of a corresponding human joint while moving. For example, an exoskeleton system described herein can include a plurality of modules. Additionally, the exoskeleton system can include at least one joint. The at least one joint can connect a thigh module to a shank module of the plurality of modules. The exoskeleton system can further include a variable stiffness actuator (VSA) system. The VSA system can include a VSA. The VSA system can be coupled with each of the thigh module and the shank module. The VSA system can drive the plurality of modules.

In another example, a method for controlling an exoskeleton described herein can involve receiving data associated with knee joint motion. The method can further involve predicting a target walking profile based on the data. Additionally, the method can involve reproducing the target walking profile by adjusting, continuously, a stiffness value of a variable stiffness actuator (VSA) system based on a portion of the target walking profile and by driving, in synchronization with a stiffness value adjustment, at least one joint.

In another example, a method for fabrication of an exoskeleton described herein can involve analyzing data associated with knee joint motion. The method can further involve optimizing a set of parameters based on the performed analysis. Additionally, the method can involve fabricating the exoskeleton based on a parameter optimization study.

### BRIEF DESCRIPTION OF THE DRAWINGS

FIG. 1 is a diagram of a representation of a patient rehabilitating with an attached compliant knee exoskeleton according to certain aspects of the present disclosure.

FIG. 2 is a schematic of a mechanical design of a compliant knee exoskeleton according to certain aspects of the present disclosure.

FIG. 3 is a diagram of a manufactured compliant knee exoskeleton according to certain aspects of the present disclosure.

FIG. 4 is a diagram of a patient resting in a sitting position with an attached compliant knee exoskeleton according to certain aspects of the present disclosure.

FIG. 5 is an exemplary plot of modeled knee stiffness during a gait cycle according to certain aspects of the present disclosure.

FIG. 6A is a simplified schematic representation of a stiffness change system under zero joint deflection for a compliant knee exoskeleton according to certain aspects of the present disclosure.

FIG. 6B is a simplified schematic representation of a stiffness change system under a spring deflection for a compliant knee exoskeleton according to certain aspects of the present disclosure.

FIG. 7 is a diagram depicting forces acting on a force contact roller (FCR) for a compliant knee exoskeleton according to certain aspects of the present disclosure.

FIGS. 8A, 8B, and 8C are an illustration of force vs pivot/FCR position graphs for various spring stiffness values for an actuation system for a compliant knee exoskeleton according to certain aspects of the present disclosure.

FIGS. 9A, 9B, 9C, and 9D are an illustration of force vs pivot position graphs for various component diameters for an actuation system for a compliant knee exoskeleton according to certain aspects of the present disclosure.

FIGS. 10A and 10B are an illustration of overall joint stiffness vs pivot/FCR position graphs for various spring stiffness values for an actuation system for a compliant knee exoskeleton according to certain aspects of the present disclosure.

FIG. 11 is an illustration of a overall joint stiffness vs pivot/FCR position graph for various spring stiffness values with an overlayed target stiffness profile for an actuation system for a compliant knee exoskeleton according to certain aspects of the present disclosure.

FIG. 12 is a graph of distance between overall joint stiffness curves and a target curve for an actuation system for a compliant knee exoskeleton according to certain aspects of the present disclosure.

FIG. 13 is a pareto plot of maximum force vs. average distance between overall joint stiffness curves and a target curve for all feasible choices of optimization parameters of an actuation system for a compliant knee exoskeleton according to certain aspects of the present disclosure.

FIG. 14 is an exploded cross-sectional view of an internal stiffness change mechanism for a compliant knee exoskeleton according to certain aspects of the present disclosure.

FIG. 15 is a schematic of a planetary gear set for a compliant knee exoskeleton according to certain aspects of the present disclosure.

FIG. 16 is a kinetic diagram of a planetary gear set showing forces on gear teeth for a compliant knee exoskeleton according to certain aspects of the present disclosure.

FIG. 17 is a kinematic diagram of a planetary gear set for a compliant knee exoskeleton according to certain aspects of the present disclosure.

FIG. 18 is a schematic of an experimental setup for characterizing stiffness of a compliant knee exoskeleton according to certain aspects of the present disclosure.

FIG. 19 is a set of exemplary graphs of torque versus joint deflection for various pivot positions of a compliant knee exoskeleton according to certain aspects of the present disclosure.

FIG. 20 is a graph that illustrates corresponding joint stiffnesses of different positions for a compliant knee exoskeleton according to certain aspects of the present disclosure.

FIG. 21 is a graph depicting a time dependence for various angles associated with a compliant knee exoskeleton according to certain aspects of the present disclosure.

FIG. 22 is a schematic diagram of system architecture and a controller block diagram for a compliant knee exoskeleton according to certain aspects of the present disclosure.

FIG. 23 is a hardware setup highlighting components associated with a compliant knee exoskeleton according to certain aspects of the present disclosure.

FIGS. 24A and 24B are exemplary graphs depicting a compliant knee exoskeleton ability to track target joint kinematics and stiffness data according to certain aspects of the present disclosure.

FIG. 25 is a flow chart of a process for designing, fabricating, and/or controlling a compliant knee exoskeleton according to certain aspects of the present disclosure.

FIG. 26 is a block diagram of a controller for a compliant knee exoskeleton according to certain aspects of the present disclosure.

### DETAILED DESCRIPTION OF THE INVENTION

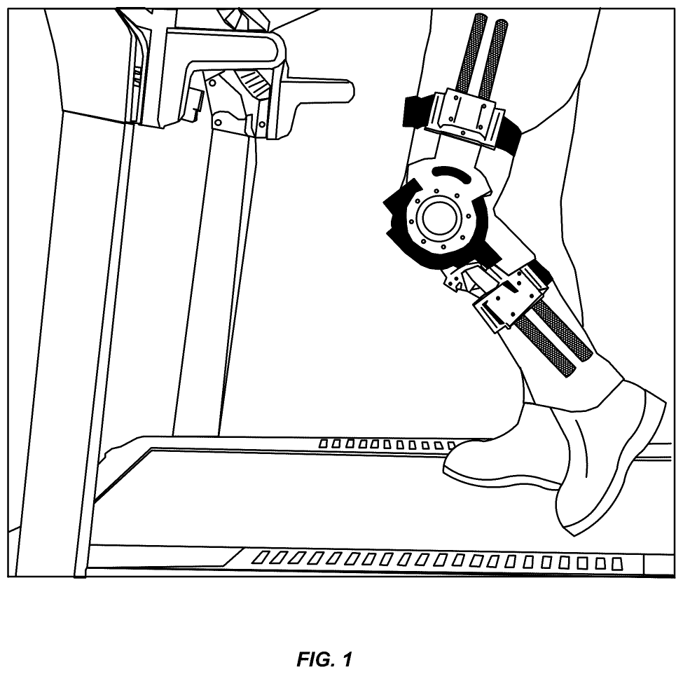

Use of assisting devices, such as exoskeletons, during rehabilitation or after treatment can significantly enhance human mobility. FIG. 1 is a diagram of a representation of a patient rehabilitating with an attached compliant knee exoskeleton according to certain aspects of the present disclosure. Several exoskeletons have been introduced in rehabilitation markets. The exoskeletons can include actuation systems with either rigid-actuation or series elastic actuators (SEAs) and only a rigid or fixed degree of compliance can be provided. But human gait data analysis can indicate that stiffness of human lower limb joints can vary during different motions or activities. For example, during a stance phase of walking, a human knee joint can exhibit a relatively high stiffness (e.g.,

$$\sim 450 \frac{Nm}{rad} )$$

compared to a much lower stiffness during a swing phase (e.g.,

$$\sim 30 \frac{Nm}{rad} ) .$$

More recent exoskeleton designs can incorporate compliant actuators, also known as variable stiffness actuators (VSAs). VSAs can include characteristics such as adaptability or safety in Human-Robot interactions. Additionally, VSAs can mimic human motion in terms of stiffness perturbations.

Compliant actuation may be important for exoskeletons due to close physical interaction with humans. Such an interaction can involve impacts and kinetic energy transfers, which can create difficulties for rigid actuators in achieving accurate position control or stable movements. These difficulties can arise especially in unpredictable environments or disturbances. Also, joint stiffness modulation can reduce transmitted forces and energy expenditure. Stiffness adaptation in exoskeletons can enhance a dissipation of external disturbances and can reduce input mechanical power. An energy efficiency of an exoskeleton can be improved by a load-adaptive variable stiffness mechanism in comparison to an exoskeleton driven by an SEA.

Certain aspects and examples of the present disclosure relate to a compliant exoskeleton design that can modulate a joint stiffness to mimic a stiffness change trajectory of a corresponding human joint while moving. For example, the compliant exoskeleton can be a knee exoskeleton that can mimic the stiffness change trajectory of a human knee joint while walking (e.g., along a gait cycle). Other examples of the compliant exoskeleton can be exoskeletons for hip joints, ankle joints, elbow joints, shoulder joints, joints of the hand, joints of the foot, etc. A design process for the compliant exoskeleton can be carried out in multiple stages to ensure robust and accurate electro-mechanical design and stiffness results. A first stage can involve main goal design specifications. The main goal design specifications can be based on human biomechanics data. In some examples, the design process can be modified to accommodate a specific patient. The main goal design specifications can be related to degrees of freedom (DoF), range of motion (ROM), torque, rotational speed, weight, size adjustability, stiffness range, or a stiffness change rate. A second stage can involve an optimization framework. The optimization framework can ensure that design parameters associated with an electro-mechanical design can achieve goal design specifications, such as stiffness goals. Objectives for the optimization framework can include: 1) a robust mechanical design that can withstand external torques associated with achieving target stiffnesses and 2) a stiffness range and change rate that can enable the compliant exoskeleton to follow a stiffness trajectory consistent with human joints during motions such as gait.

A full electro-mechanical design of the compliant exoskeleton can include a compliant mechanism (e.g., a variable stiffness joint) that can involve changing a transmission ratio between an output and an elastic element. An ability to change the transmission ratio can assist in achieving accurate control of transmitted torques between the compliant exoskeleton and a human, enabling a safer human-robot interaction than that of conventional exoskeletons.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

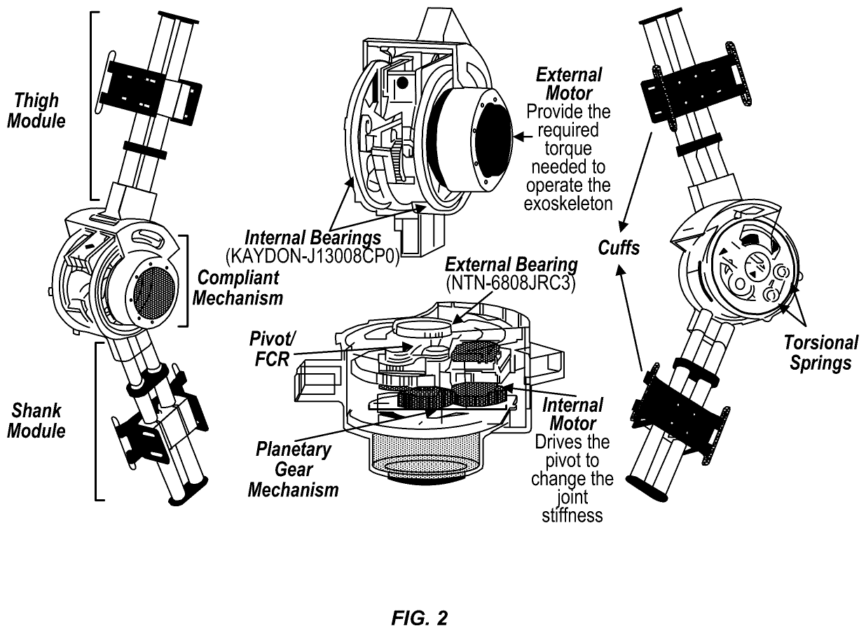

FIG. 2 is a schematic of a mechanical design of a compliant knee exoskeleton according to certain aspects of the present disclosure. A thigh module of the compliant knee exoskeleton can represent a fixed part of a compliant mechanism. A stationary side (e.g., a stator) of an external motor (e.g., a T-motor AK-64) can be attached to the thigh module. A motor shaft (e.g., a rotor) can drive an input part of the compliant mechanism. The compliant mechanism can also contain a planetary gear mechanism driven by an internal servomotor.

The planetary gear mechanism can be responsible for changing a location/cylindrical pivot of a force contact roller (FCR). The cylindrical pivot can slide between two torsional springs to alter joint stiffness. An output part of the compliant mechanism can be a hollow cylinder that is open from one side to allow a connection between a motor shaft and the input part. The hollow cylinder can be closed on an other side in which the torsional springs can be secured. An output of the compliant mechanism can include a torque transmitted to a shank module. Coupling between the input and the output parts can be controlled with an interaction between the cylindrical pivot and an elastic element (e.g., the torsional springs). The coupling can be governed by the pivot location.

Two large bearings can allow the input and output parts to rotate with respect to each other when a torsional spring is deflected. The shank module can be connected to the output part. Different joint stiffnesses can be realized for each corresponding pivot location. A selection of main design parameters, such as spring stiffness, diameters of the pivot cylinder, or a diameter f a spring base cylinder can be based on an optimization framework. The optimization framework can ensure a robust design for the compliant knee exoskeleton. The compliant knee exoskeleton can precisely follow a stiffness trajectory associated with a human knee joint.

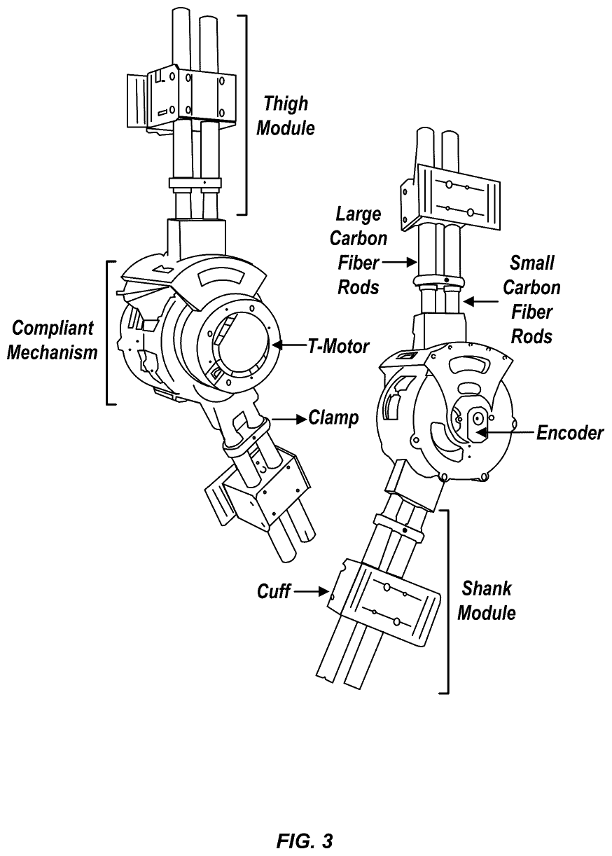

FIG. 3 is a diagram of a manufactured compliant knee exoskeleton according to certain aspects of the present disclosure. Thigh and shank modules of the compliant knee exoskeleton can be constructed from lightweight hollow carbon fiber rods. The carbon fiber rods can have different diameters and can be connected with an adjusting clamp. Thus, lengths can be adjusted for different users. A majority of parts of the compliant knee exoskeletons can be 3D printed using polylactic acid (PLA), (e.g., Tough PLA) 3D printing material. Internal parts (e.g., gears, shafts, springs, etc.) of a variable stiffness mechanism can be made of steel to resist large spring forces associated with high stiffness states.

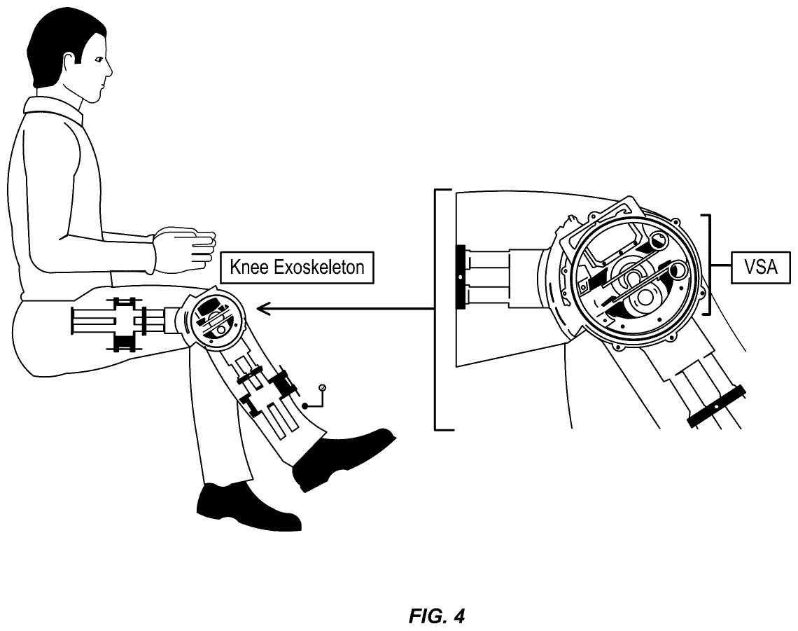

FIG. 4 is a diagram of a patient resting in a sitting position with an attached compliant knee exoskeleton according to certain aspects of the present disclosure. The diagram includes a zoomed in view of a VSA or compliant mechanism for the knee exoskeleton.

Design specifications for the compliant knee exoskeletons can be identified through a study of mechanics of the human knee joint. Main design specifications can include degrees of freedom (DoF), range of motion (RoM), joint rotational speed, joint torque, stiffness range, or stiffness change rate. An adjustability of the design to adapt for different users can also be considered. These specifications can be based, in part, on an analysis of human knee joint biomechanics.

Healthy knee joint positions, rotational velocities, and torques can be investigated and plotted for different activities including staircase ascent or descent, sit to stand, and level walking. Such data can illustrate that a maximum torque associated with a healthy knee joint during level walking can be approximately 40 Nm. The maximum torque can vary depending on the activity and can reach up to 105 Nm for stair descent. Additionally, a ROM of 10°-105° can be associated with the knee exoskeleton to account for all of the aforementioned activities. For level walking, a RoM of 10°-60° may be sufficient. Also, a knee joint rotational speed of approximately 50 rpm can provide a walking speed of almost

$$1 \frac{m}{s} - 1.5 \frac{m}{s} ,$$

which can closely match an average human walking speed.

A model can be developed to estimate target stiffness for the compliant knee exoskeleton. In the model, muscle forces and a stiffness range can be estimated using static optimization (from knee joint torques) and electromyography EMG sensors. The forces and stiffness range can be mapped to calculate joint stiffness during a gait cycle. The model can be verified experimentally with perturbation techniques. The model can generate a simplified possible implementation of stiffness modulation values for the exoskeleton design.

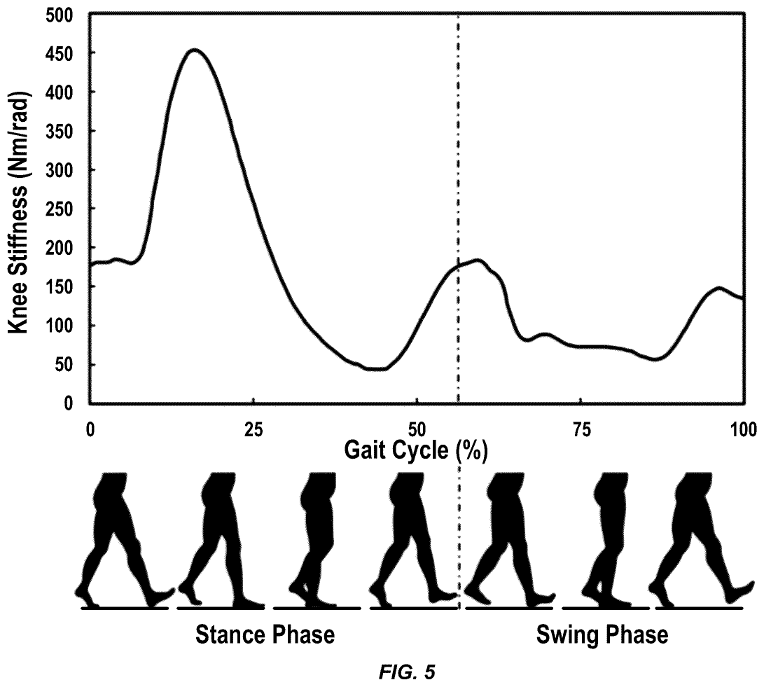

FIG. 5 is an exemplary plot of modeled knee stiffness during a gait cycle according to certain aspects of the present disclosure. A human knee exhibits significant variations in stiffness throughout the gait cycle. At first, knee stiffness can undergo a rapid increase, rising from about

$$180 \frac{Nm}{rad} to 450 \frac{Nm}{rad}$$

during a first quarter of the gait cycle during a stance phase. In later stages of the stance phase, knee stiffness can reduce considerably, falling to approximately

$$30 \frac{Nm}{rad}$$

before returning to an initial value at a start of the gait cycle.

Knee stiffness during a swing phase can exhibit smaller perturbations compared to the stance phase. Thus, the compliant knee exoskeleton can be designed to exhibit fast adjustments in stiffness during an initial phase of the gait cycle, while achieving slower changes in stiffness during the swing phase. A target stiffness range (e.g.,

$$30 \frac{Nm}{rad} to 450 \frac{Nm}{rad} )$$

can be defined for the knee exoskeleton. Further, considering that an average gait cycle time can be approximately 1-1.5 second, and since a large sudden drop in stiffness can occur within a first 20% of the gait cycle, a target time to change stiffness over the target stiffness range can be about 0.2-0.3 seconds. Such target specifications, summarized in Table 1, can enable the knee exoskeleton to mimic a human knee stiffness trajectory curve.

TABLE 1
Summary of design parameters for a compliant knee exoskeleton.

| | One actuated DoF for knee |
|---|---|
| Degrees of Freedom (DoF) | flexion/extension motion |
| Range of Motion (RoM) | 10°-60° |
| Maximum Continuous Torque | 40 Nm |
| Weight (without batteries) | <3 Kg |
| Joint Rotational Speed | 50 rpm |
| Size | Adjustable for multiple |
| | user heights |
| Stiffness Range | $30 \frac{Nm}{rad} - 450 \frac{Nm}{rad}$ |
| Stiffness change time | 0.2-0.3 seconds over full range |

As noted above, stiffness of the compliant knee exoskeleton can be altered by changing a transmission ratio between an output link and an elastic element (e.g., torsional springs) using an adaptable pivot/force contact roller (FCR). An actuator/knee position can be decoupled from stiffness control. The knee joint position can be controlled using a high torque motor or external motor, and the stiffness can be controlled by a smaller servomotor or internal motor that can drive the FCR.

A compliant mechanism can include two torsional springs and a cylindrical FCR that can slide in a linear motion between the two torsional springs. One of the torsional springs can be left-handed and the other can be right-handed. An inner part of the compliant mechanism can be attached to a shank module and can include a cylinder with a base that can encapsulate a mechanism that drives the FCR. An outer member of the compliant mechanism can be attached to a thigh module and can enclose the inner part. The inner part and outer part can be coupled by an interaction between the FCR and the torsional springs.

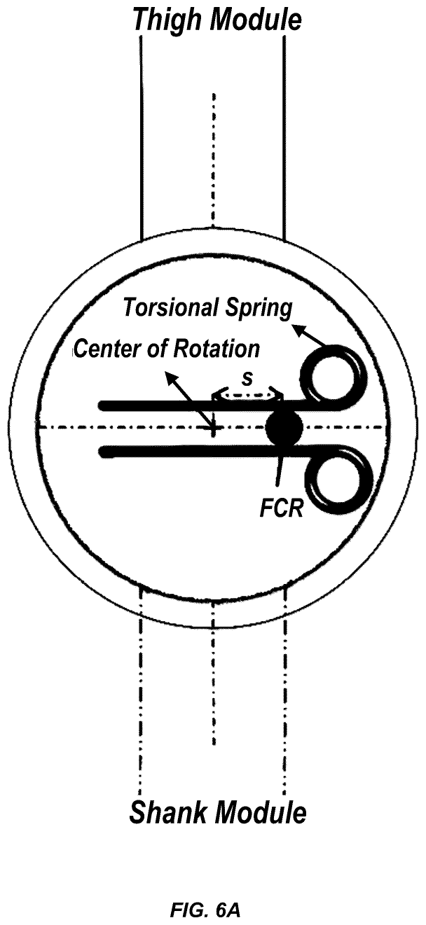

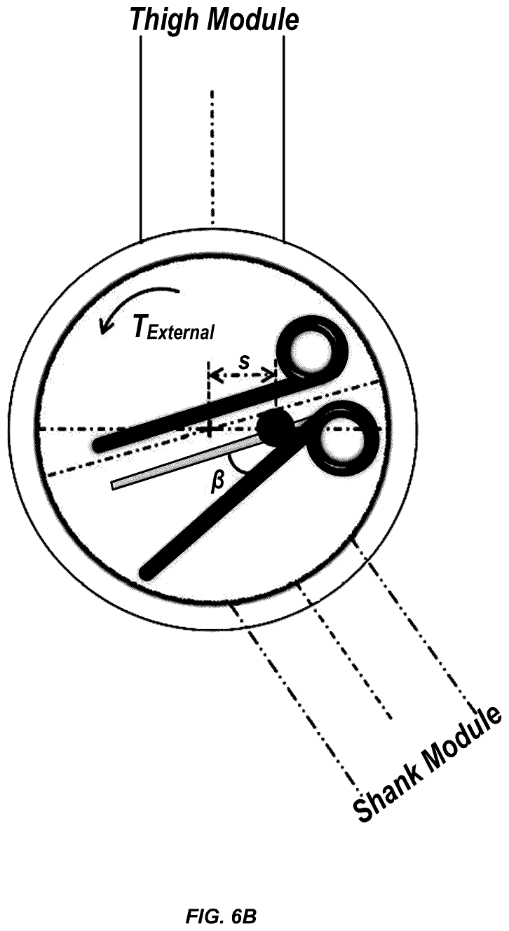

FIG. 6A is a simplified schematic representation of a stiffness change system under zero joint deflection for a compliant knee exoskeleton according to certain aspects of the present disclosure. When an external torque (Tₑₓₜ) acts on an inner member of a compliant mechanism of the knee exoskeleton, motion of a shank module can be governed by an FCR position. When an external torque of zero is applied, the shank module can remain stationary. FIG. 6B is a simplified schematic representation of a stiffness change system under a spring deflection for a compliant knee exoskeleton according to certain aspects of the present disclosure. When the FCR starts sliding between two torsional springs and reaches a specific position (s) away from a joint center, the external torque can be transmitted through the torsional springs to the shank module. A corresponding torsional spring can exhibit a deflection (β). An amount of the deflection can be influenced by multiple parameters such as a spring constant (Kₛ), an FCR diameter (D_{fcr}), and a spring base diameter (Dₛₚ). When such parameters are optimized to achieve a target stiffness range, joint stiffness can be controlled via the FCR position relative to the joint center. If the FCR slides away far enough to interact with a base cylinder of a torsional spring, an interaction force can become rigid without a corresponding deflection.

Forces acting on the FCR, due to an external torque can be given by the following expression in an elastic case:

$$‖ \vec{{F}_{s}} ‖ = \frac{‖ \vec{{T}_{s}} ‖}{{L}_{s}} = \frac{{K}_{s} β}{{L}_{s}} \qquad ( 1 )$$

and by the following in a rigid case:

$$‖ \vec{{F}_{s}} ‖ = \frac{‖ \vec{{T}_{ext}} ‖}{‖ \vec{A} ‖} \qquad ( 2 )$$

where Fₛ is force action on the FCR, Tₛ is the torque of a torsional spring, Lₛ is an active length of a spring arm, β is a deflection of the spring, Tₑₓₜ is an external torque applied to the joint, and \vec{A} is a vector defined from an actuator center of rotation perpendicular to the Fₛ vector. Joint stiffness can be calculated by estimating a ratio of external torque to joint deflection:

$${K}_{α} = \frac{δ ‖ \vec{{T}_{ext}} ‖}{δ α} \qquad ( 3 )$$

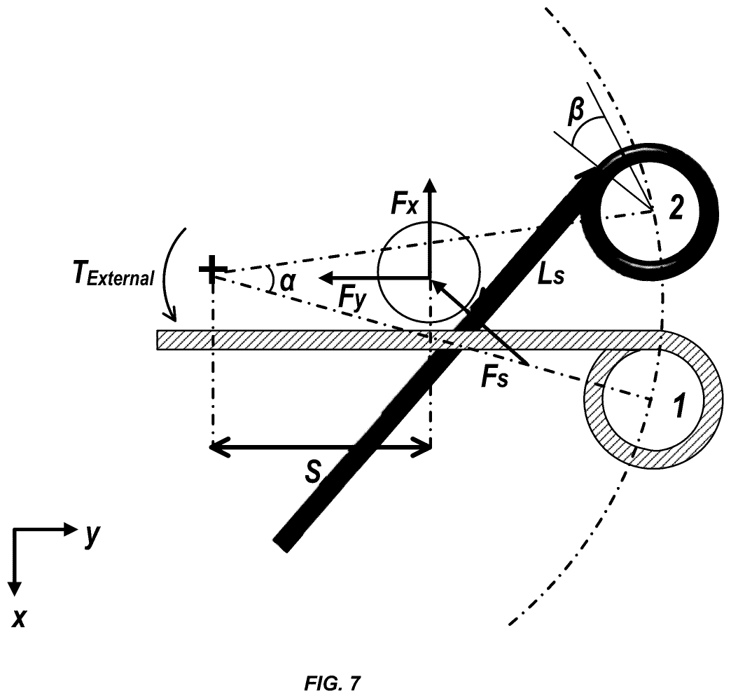

FIG. 7 is a diagram depicting forces acting on an FCR for a compliant knee exoskeleton according to certain aspects of the present disclosure. The forces can be present when a torsional spring is deflected from a position 1 to a position 2 with a deflection β. Three separate angles can be relevant in such a scenario. The spring deflection angle β can define an amount of deflection that occurs to the torsional spring due to a joint rotation. A joint deflection angle α can correspond to a deflection of a joint due to the spring deflection. A joint rotation angle θ can define a rotation angle (or angular position) of a compliant knee exoskeleton, developed between thigh and shank modules.

### Design Optimization

An optimization of main design parameters of the actuation system can be conducted for a design that may be useful for exoskeleton applications. Two optimization criteria/performance metrics for the actuation system can illustrated. In addition, optimization variables describing the physical design parameters can be defined.

Stiffness can characterized by assuming all forces acting on the FCR are elastic. However, to accurately estimate force exerted on the FCR, both elastic and full contact scenarios may be considered. An assumption that the forces are all elastic can results in non-realistic/extremely high forces for small values of an effective arm length (Lₛ) of the spring. Thus, a non-elastic behavior can be considered when (Lₛ) is very small, which can occur when the FCR is very close to a spring base and a joint is deflected.

When such a force acts on the FCR, the force can cause bending of an FCR rod (e.g., shaft) or back drive/break a driving mechanism. To avoid breaking the driving mechanism, a maximum possible reaction force can be minimized. Thus, a first performance metric (optimization criterion) can be described by:

$$‖ {\vec{F}}_{d e s} ‖ = Min ( \{ ‖ {\vec{F}}_{max} ‖ \} ) = Min ( Max ( \{ ‖ {\vec{F}}_{s} ‖ \} ) ) \qquad ( 4 )$$

where \vec{F}_{des} is a desired or target force, and:

$$‖ {\vec{F}}_{s} ‖ = \frac{{K}_{s} β}{{L}_{s}} for ( {L}_{s} > 3 mm ) \qquad ( 5 )$$

$$‖ {\vec{F}}_{s} ‖ = \frac{‖ {\vec{T}}_{ext} ‖}{‖ \vec{A} ‖} for ( {L}_{s} \leq 3 mm ) \qquad ( 6 )$$

Conversely, minimizing the reaction force can affect overall joint stiffness performance. Thus, a second objective function can represent an adoption of a stiffness performance (e.g, a performance defined by a stiffness versus pivot position relationship) for the actuation system that can be as close as possible to a specific function that describes a desired stiffness behavior/requirements for an intended application, (e.g., for a knee exoskeleton.) Matching the second objective function to the specific function that describes the desired stiffness behavion can involve calculating an average distance between two curves. The first curve can represent a desired stiffness change behavior, whereas, the second curve can be a stiffness function that describes actuator stiffness for a specific set of design parameters within search limits for optimization variables. The average distance calculation between two curves can be repeated for all possible combinations of design parameters. By minimizing the calculated average distance, selected design parameters can result in optimum stiffness change behavior compared to the desired or target stiffness change behavior. Therefore, a second performance metric can be represented as:

$${D}_{avg} = Min ( \frac{{\sum }_{n} abs ( {K}_{α} - {K}_{d} )}{n} ) \qquad ( 7 )$$

where D_{avg} is the mean distance between the two curves and

$${K}_{α} = \frac{δ ( {\vec{T}}_{ext} )}{δα}$$

vs s can represent an overall actuator stiffness (variation of elastic torque with joint deflection) change with s. K_{d} vs s can be a target stiffness behavior variation with s and n can be a number of included data values.

The objective functions can depend on a spring stiffness constant (Kₛ), the spring arm active length (Lₛ), and a spring angular deflection (β) which can be a function of a distance (s) and a joint deflection angle (α). These variables can be represented by three main physical design parameters including the spring stiffness constant (Kₛ), an FCR diameter (D_{fcr}), and a diameter of a spring base circle (Dₛₚ). These parameters can be assigned as decision variables. Furthermore, to perform a grid search optimization, specific constraints for each of these variables can be introduced as follows.

Constraints for spring stiffness can be defined based on a parametric analysis, such that the constraints help to avoid an extremely high force that may damage a driving mechanism. Conversely, the constraints should lead to a sufficient overall joint stiffness compared to targeted joint stiffness. A search within a range of 2 Nm/rad to 12 Nm/rad can be conducted.

Both the diameters of the spring base circle and the FCR can be selected depending on an application. Constraints can be designed such that a spring base does not intersect with an outer diameter of the actuator cylinder. In addition, constraints can ensure a sufficient distance (s) for the FCR to slide between the spring arms without interacting with the spring base immediately (e.g., transferring to a non-elastic region). For simplicity, an actuator diameter of 125 mm can be assumed. In other examples, the actuator diameter can take on other values that are different from 125 mm. Based on an assumption of 125 mm for the actuator diameter, limits for both the FCR and spring base circle diameters can be set between 5 mm and 21 mm. Such limits can allow the FCR to move up to 40 mm from an actuator center.

Prior to an optimization process, a parametric analysis for the three main design parameters can be conducted in order to separately study an effect of the main design parameters on the optimization functions. In the following description of parametric analysis, an effect of changing each of the main design parameters on both a maximum force acting on the FCR (F_{des}) and an overall joint stiffness behavior (K_{α} vs s) is discussed.

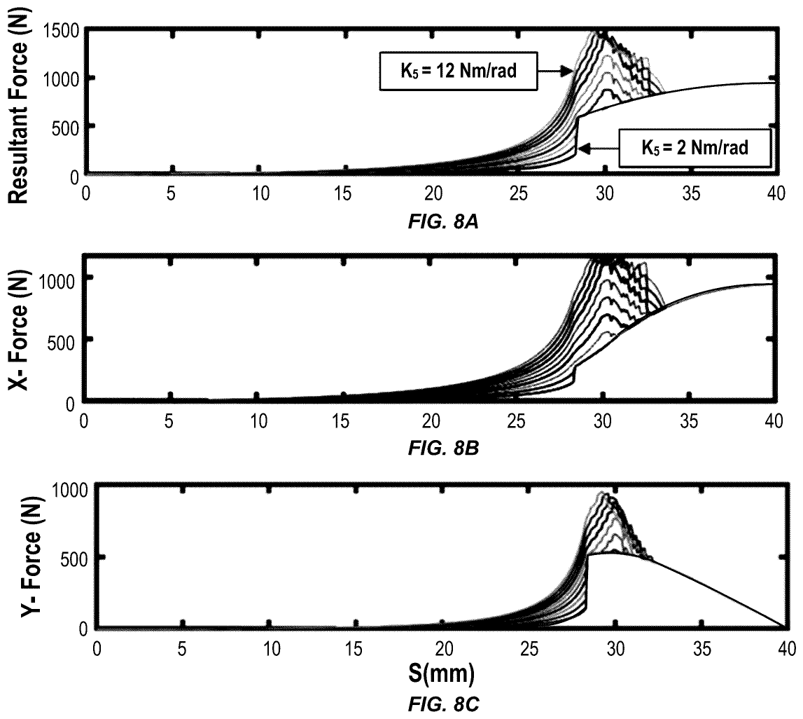

FIGS. 8A, 8B, and 8C are an illustration of force vs pivot/FCR position graphs for various spring stiffness values for an actuation system for a compliant knee exoskeleton according to certain aspects of the present disclosure. Maximum forces can be presented for each s position when an actuator is deflected up to a corresponding deflection angle (α). Each of the curves can describe one value of Kₛ. s can be assumed fixed to a specific value and an output arm can be rotated until reaching a specific αₘₐₓ. A determination of how the force changes with α can be made and a maximum force can be extracted. Such calculations can be repeated for each s from zero up to 40 mm with a 0.1 mm increment. The maximum forces can be plotted for each s.

Plots in FIGS. 8A-8C show that up to a specific s value, no interaction may occur between the FCR and the spring base circle diameter. Thus, all forces acting on FCR in a range can be elastic. When both of the circles become closer to each other (s increases), the force developed can start out as elastic but when α is increased (e.g., the output arm is rotated), the circles can start interacting and the force acting on the FCR can become rigid.

Moreover, for lower values of Kₛ, even maximum values of the elastic forces can be very small. Hence, a significant increment in maximum force values can appear when the force becomes rigid (e.g., the FCR and the spring base cylinder start interacting). However, when Kₛ increases, the elastic forces can exhibit even higher values than the rigid forces. Overall, when spring stiffness increases, higher forces can be observed as expected.

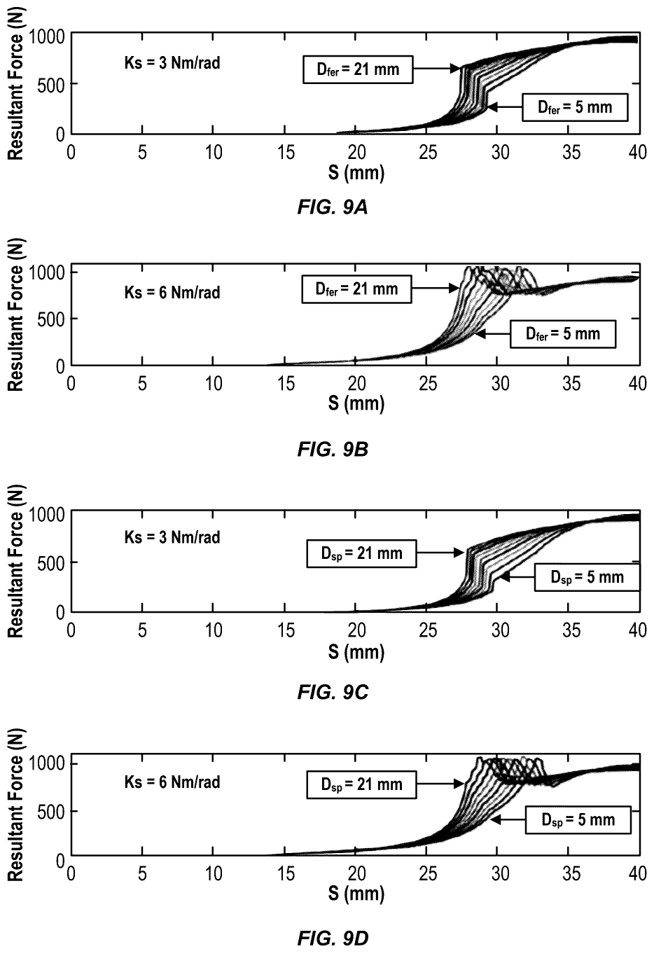

FIGS. 9A, 9B, 9C, and 9D are an illustration of force vs pivot position graphs for various component diameters for an actuation system for a compliant knee exoskeleton according to certain aspects of the present disclosure. Both diameters (D_{fcr} and Dₛₚ) of the cylinders can exhibit a similar effect on maximum forces. Overall, both diameters can slightly affect values of the maximum force compared to the spring stiffness. These effects can be due to a small change that occurs to spring arm active length (Lₛ) as either of the diameters is altered.

For relatively small spring stiffness and upon reaching a specific s where an interaction between the two cylinders can occur, rigid forces can dominate and appear as maximum forces, occurring at higher values of s. Such an effect can be observed by a transition (e.g., elastic to rigid) delay that can occurs when either of the two diameters is reduced. Conversely, when the spring stiffness is increased, elastic forces can exhibit higher values before an FCR and spring base cylinder interaction. A transition (e.g., elastic to rigid) delay can be noticed again when a diameter is decreased.

Both D_{fcr} and Dₛₚ can have a small effect on spring force values. The effect of both diameters on the overall joint stiffness can be small. Conversely, the spring stiffness can be directly proportional to an exhibited elastic torque. Therefore, an effect of spring stiffness on the overall joint stiffness can be considerable.

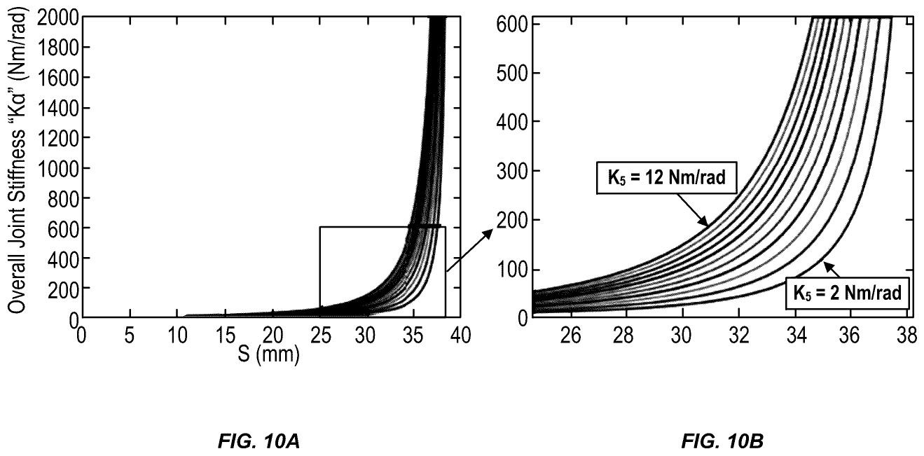

FIGS. 10A and 10B are an illustration of overall joint stiffness vs pivot/FCR position graphs for various spring stiffness values for an actuation system for a compliant knee exoskeleton according to certain aspects of the present disclosure. An effective joint stiffness region can be enhanced by increasing a stiffness of an engaged spring. Thus, for larger Kₛ, the overall joint stiffness can be easily altered by changing s (e.g., moving an FCR). Whereas, for smaller Kₛ, the overall joint stiffness can be almost constant for a wide range of s.

Stiffness can change effectively when s is roughly between 25 mm and 37 mm. A linear behavior can be chosen for movement of the FCR (e.g., s displacement) which can represent a target stiffness change. However, different slopes for a linear relationship can be selected so that, in a last 5 mm of s, a higher slope for a linear function can be implemented to follow a rapid stiffness increment (e.g., from 180 to 450 Nm/rad) that can occur to a knee joint during a stance phase of a gait cycle. A grid search within the optimization variables can be performed to generate a solution.

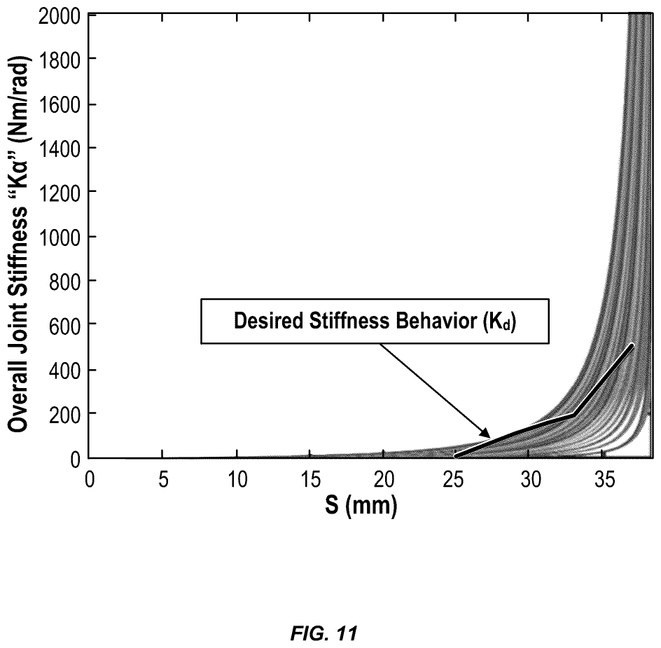

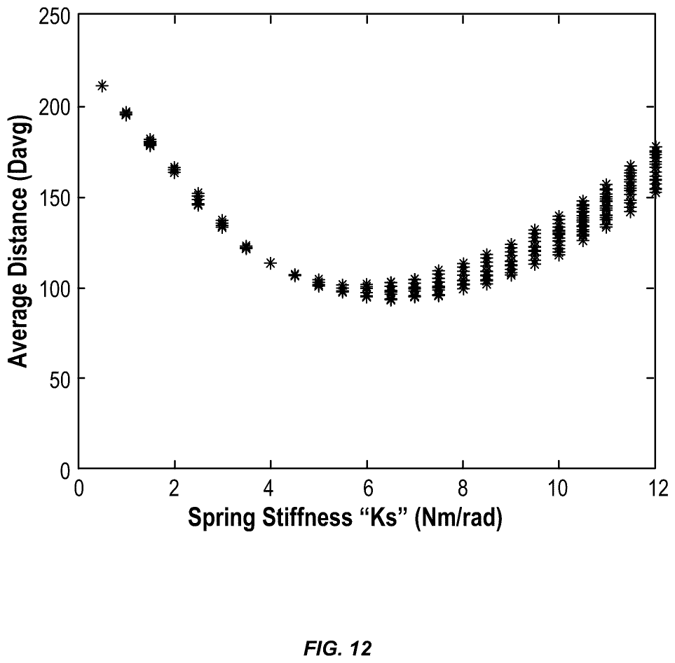

FIG. 11 is an illustration of a overall joint stiffness vs pivot/FCR position graph for various spring stiffness values with an overlayed target stiffness profile for an actuation system for a compliant knee exoskeleton according to certain aspects of the present disclosure. FIG. 12 is a graph of distance between overall joint stiffness curves and a target curve for an actuation system for a compliant knee exoskeleton according to certain aspects of the present disclosure. The distance between all curves of (K_{α}) and the target stiffness (K_{d}) curve can be calculated for all points within an effective stiffness change region. An average distance for each curve can be plotted with one of the optimization variables (Kₛ). As an example, using a spring with stiffness of (5.5-6.5) Nm/rad can ensure a close overall joint stiffness behavior compared to targeted stiffness behavior.

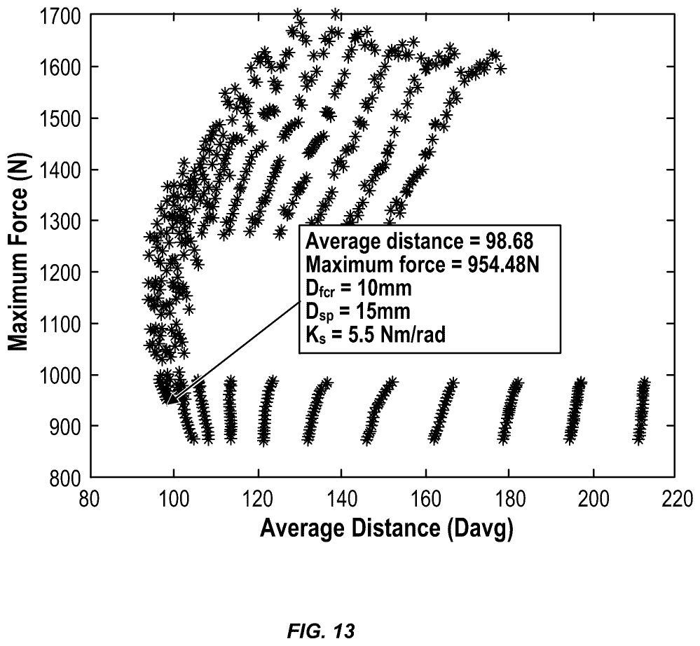

FIG. 13 is a Pareto plot of maximum force vs. average distance between overall joint stiffness curves and a target curve for all feasible choices of optimization parameters of an actuation system for a compliant knee exoskeleton according to certain aspects of the present disclosure. Each point in the figure can correspond to a specific set of design parameters. An optimal solution can be extracted from the Pareto plot by selecting a point that ensures a minimization of both objective functions. A solution with a similar stiffness behavior to a targeted stiffness behavior and with a smallest Fₘₐₓ acting on the FCR can correspond to design parameters of an optimal solution including D_{fcr}=10 mm, Dₛₚ=15 mm, and Kₛ=5.5 Nm/rad, or to values close to these optimal solution parameters. An associated force on the FCR can be approximately 954 N. Although these values are listed as examples of optimal values, other values for the design parameters can be used.

Based on the optimal solution parameters, the planetary gear mechanism implemented in the compliant knee exoskeleton can resist forces up to approximately 1275 N before motor stalling (e.g., without back-driving or hindering motor motion), since a maximum force associated with the optimal solution parameters (e.g., 954 N) can be less than a maximum force that the planetary gear mechanism can handle (e.g., 1275 N). The planetary gear mechanism can be driven by, for example, a Dynamixel servomotor. Additionally, selecting the optimal solution parameters (e.g., D_{fcr}=10 mm, Dₛₚ=15 mm, and Kₛ=5.5 Nm/rad) for use in the compliant knee exoskeleton can ensure that the compliant knee exoskeleton achieves target stiffness performance. Thus, both objective functions for the compliant knee skeleton can be achieved.

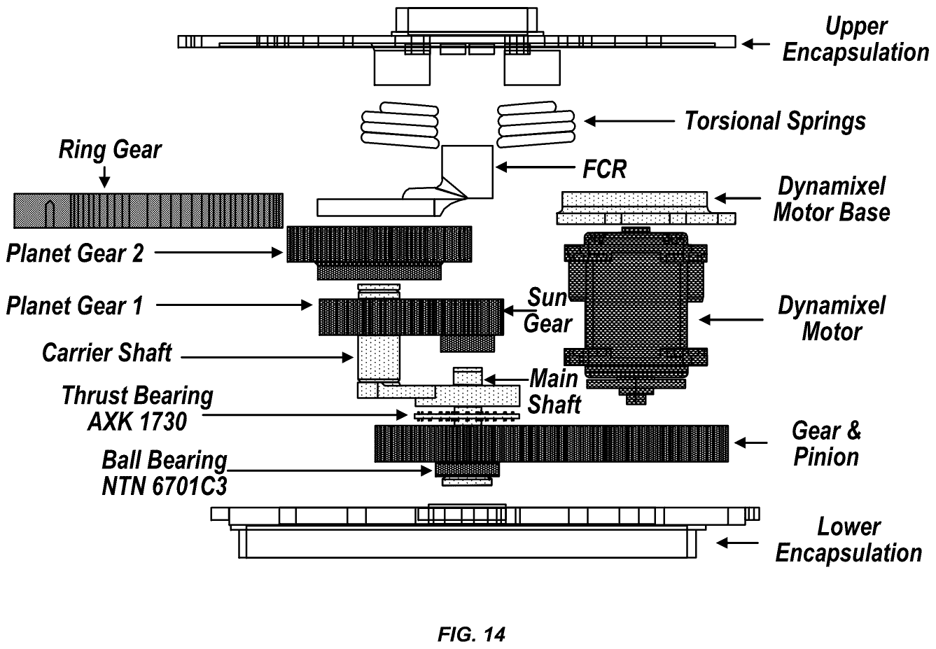

FIG. 14 is an exploded cross-sectional view of an internal stiffness change mechanism for a compliant knee exoskeleton according to certain aspects of the present disclosure. The internal stiffness change mechanism can include three main components. The main components can include an internal servomotor (e.g., Dynamixel motor), a planetary gear mechanism, and two torsional springs. The planetary gear mechanism can include a plurality of gears, shafts, and bearings. The planetary gear mechanism can be driven by the servomotor. A spur gear can be attached to a shaft of the servomotor and connected to a pinion of a similar type. A sun gear can be placed above the pinion and both the sun gear and the pinion can rotate on a main shaft with a key connection.

A carrier shaft can rotate on a thrust bearing above the pinion gear. Thus, the carrier shaft rotation can be independent of the pinion and sun gears. The sun gear can drive a first planet gear and a second planet gear can be fixed to the first planet gear. The second planet gear can mate with a ring gear that can be fixed to an encapsulation wall. Only half of a ring gear may be important since a target range for a displacement s of an FCR can be achieved without full planet gear rotation. Since only half of the ring gear may be important, a weight and size for the mechanism can be reduced. An FCR cylinder can be secured on an upper surface of the second planet gear.

A diameter of the second planet gear can be half a diameter of the ring gear. Thus, cycloidal motion realized by a tangent of the second planet gear, where the FCR can be attached, can be linear. An external torque (Tₑₓₜ) can be exerted by an external motor. A resulting joint deflection (α) can be allowed by two large bearings corresponding to a deflection of a torsional spring. A joint can rotate with a rotation angle (θ) around an external bearing to drive a shank module along a target knee position trajectory.

A kinetic and kinematic analysis can assist in a selection of gears and springs for the internal stiffness change mechanism. The kinematic analysis can estimate position and velocity of the FCR, which can be important for accurate stiffness control. The kinetic analysis can estimate moments and forces acting on internal mechanism components due to an applied external torque (Tₑₓₜ). The external torque can cause a large spring force (Fₛ) acting on the FCR. The spring force can counteract motion of the FCR driven by a planetary gear set and the internal servomotor.

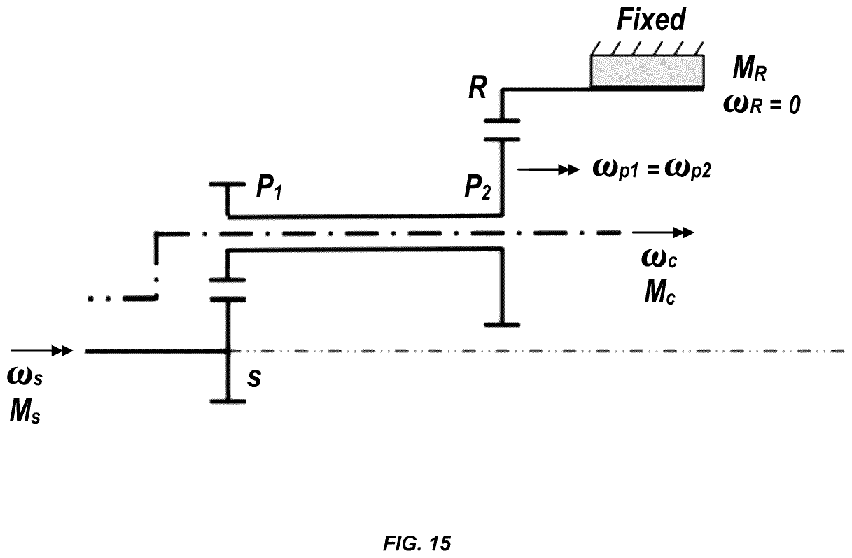

FIG. 15 is a schematic of a planetary gear set for a compliant knee exoskeleton according to certain aspects of the present disclosure. An input moment (Mₛ) can be exerted by a sun gear driven by a servomotor operating at a rotational velocity (ωₛ). The input moment can be transmitted through a first planet gear (P₁) and a second planet gear (P₂) to a ring gear (R). Since the ring gear can be fixed to a wall, a moment M_{c} can drive a carrier shaft with a rotational velocity ω_{c}. Assuming a maximum amount of torque can be transmitted through gears for a safe design, in equilibrium, the following two expressions are valid:

$${M}_{s} + {M}_{R} + {M}_{c} = 0 \qquad ( 8 )$$

$$- {M}_{s} \frac{{N}_{p 1}}{{N}_{s}} + {M}_{R} \frac{{N}_{p 2}}{{N}_{R}} = 0 \qquad ( 9 )$$

where Nₚ₁, Nₚ₂, Nₛ, and N_{R} are numbers of teeth for each corresponding gear. A maximum transmitted moment (M_{c}) can be calculated by substituting Mₛ as a peak torque of the servomotor. The transmitted moment can be counteracted by a back-driving moment resulting from a spring force Fₛ. The back-driving moment can be found from:

$${M}_{backdriving} = ( {F}_{x} cos ψ + {F}_{y} sin ψ ) \times {r}_{c} \qquad ( 10 )$$

The term in brackets in (10) can represent a force acting tangentially on the carrier shaft resulting from Fₛ. Fₓ and F_{y} are components of Fₛ, ψ, which can change for different s positions, is a rotation angle developed between an x-direction and a tangent of the carrier shaft, and r_{c} is a radius of carrier shaft rotation. Thus, Fₛ can be restricted such that the resulting M_{backdriving} may not exceed M_{c}. Minimizing the spring force can be done by reducing an amount of external torque exerted on the system or choosing springs with a small stiffness constant. But, design characteristics can indicate that the external torque can reach up to a value of

$$40 \frac{N m}{r a d} .$$

Implemented torsional springs can provide a defined goal stiffness performance based on optimization analysis. Other important parameters can contribute to a realized joint stiffness and a corresponding spring force Fₛ. Three main design parameters can include a torsional spring constant Kₛ, a diameter of a torsional spring base circle Dₛₚ, and a diameter of the FCR D_{fcr}. Defining these main design parameters can be accomplished by formulating an optimization problem that causes at least two primary objection functions are meant. Selecting the main design parameters by solving the optimization problem can ensure that the resulting spring force Fₛ does not generate a moment exceeding M_{backdriving}, even if a maximum external torque is applied, while also maintains a stiffness performance capable of matching a target stiffness trajectory. Optimized main design parameters can be about:

$${K}_{s} = 5.7 \frac{Nm}{rad} ,$$

$${D}_{fcr} = 13 mm ,$$

$$and$$

$${D}_{sp} = 15 mm .$$

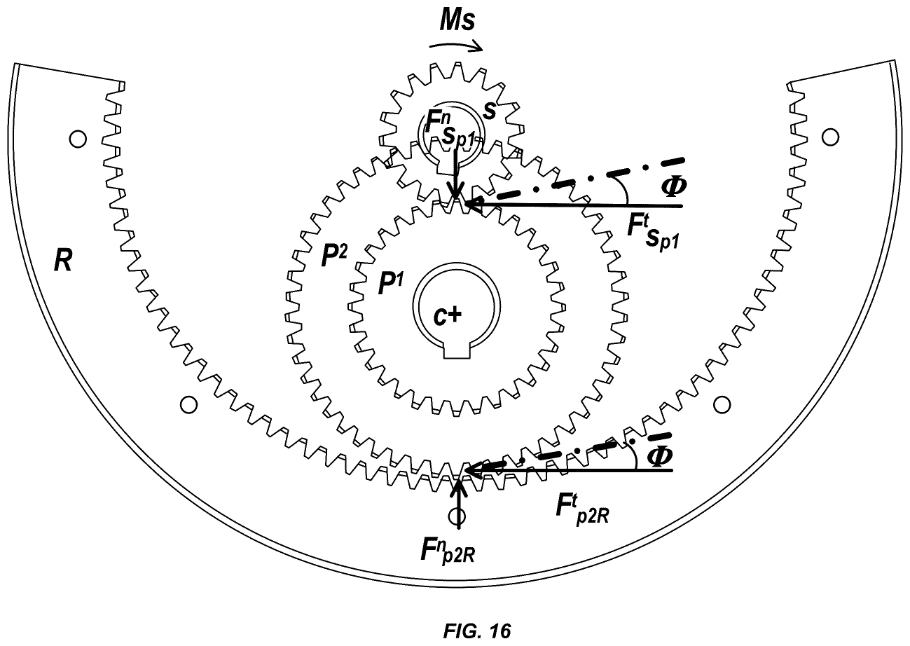

Additionally, forces between mating gears can be calculated to optimize gear selection to avoid bending or fracturing of gear teeth. FIG. 16 is a kinetic diagram of a planetary gear set showing forces on gear teeth for a compliant knee exoskeleton according to certain aspects of the present disclosure. A tangential force due to a P1-s mating can be defined as a moment divided by a moment arm:

$${F}_{sp 1}^{t} = \frac{{M}_{s}}{{r}_{s}} \qquad ( 11 )$$

whereas a tangential force developed between gears P2-R can be estimated by solving static equilibrium expressions around a carrier shaft (e.g., point c):

$$\sum {M}_{c} = I {α}_{c} = 0 \qquad ( 12 )$$

$${F}_{s p 1}^{t} \times {r}_{p 1} - {F}_{p 2 r}^{t} \times {r}_{p 2} = 0 \qquad ( 13 )$$

Normal forces can be calculated from a gear pressure angle ϕ. All gears described in the planetary gear set can be selected to resist forces resulting from a maximum motor torque.

A kinematic analysis can be applied to determine expressions for position and velocity of the FCR, since these expressions can be useful for stiffness control. Referring to FIG. 15, the following expressions describe relations between rotational velocities based on corresponding gear ratios between mating gears:

$$\frac{{ω}_{s} - {ω}_{c}}{{ω}_{p 1} - {ω}_{c}} = - \frac{{N}_{p 1}}{{N}_{s}} \qquad ( 14 )$$

$$\frac{{ω}_{R} - {ω}_{c}}{{ω}_{p 2} - {ω}_{c}} = \frac{{N}_{p 2}}{{N}_{R}} \qquad ( 15 )$$

since first planetary gear P1 and second planetary gear P2 can be pin attached and a ring gear is static, ωₚ₁=ωₚ₂ and ω_{R}=0. Thus a relationship between input and output velocities can be determined:

$${ω}_{s} = ( \frac{{N}_{p 1} {N}_{R}}{{N}_{s} {N}_{p 2}} + 1 ) {ω}_{c} \qquad ( 16 )$$

A term in brackets in (16) can be calculated as, for example, 4.56 based on a gear selection, implying that:

$${θ}_{s} = 4.56 {θ}_{c} \qquad ( 17 )$$

Equation (17) can be helpful in calculating an FCR position. Note, a velocity (input velocity) of a sun gear can equal a velocity provided by an internal servomotor (ωₛ=ωₛₑᵣᵥₒ), since the velocity can be transmitted through a gear and pinion of equivalent size.

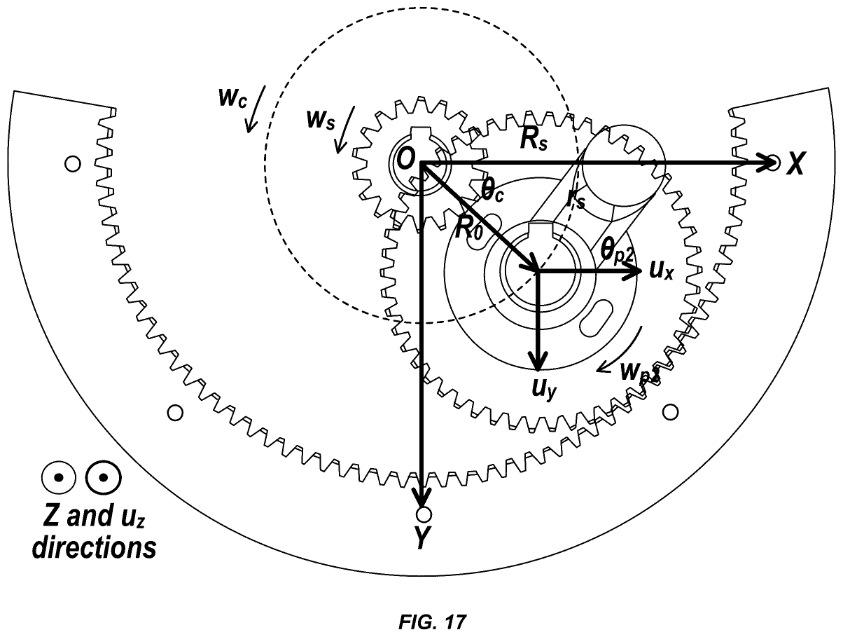

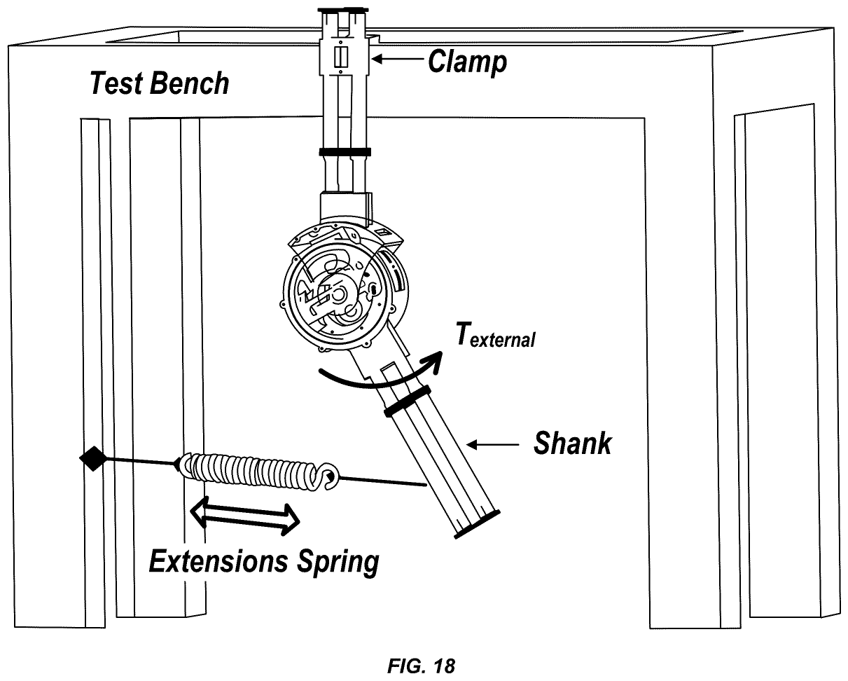

Position and velocity of the FCR can be derived using rigid body dynamic analysis. FIG. 17 illustrates a kinematic diagram for a planetary gear set. An inertial reference frame can be defined as fixed to a center of rotation (X-Y frame) of a joint and a moving frame can be defined as attached to a center of a carrier shaft (uₓ-u_{y} frame). Based on the inertial reference frame and the moving frame, parameters can be defined including a carrier shaft angle (θ_{c}), a planet gear 2 rotation angle (θₚ₂), and three main vectors to define a location of the FCR. From FIG. 18, a position of the FCR in a reference frame can be defined as:

$${\vec{R}}_{s} = {\vec{R}}_{0} + {\vec{r}}_{s} \qquad ( 18 )$$

Velocity expressions can be calculated by differentiating (18) with respect to time:

$$\frac{d {\vec{R}}_{s}}{d t} = \frac{d {\vec{R}}_{0}}{d t} + \frac{d {\vec{r}}_{s}}{d t} \qquad ( 19 )$$

Referring to rigid body dynamics analysis, the velocity of the FCR can be given by:

$$\vec{{V}_{s}} = {\vec{V}}_{0} + {\vec{V}}_{rel} + {\vec{ω}}_{p 2} \times {\vec{r}}_{s} \qquad ( 20 )$$

where \vec{V}₀ is the velocity of the moving frame, \vec{V}ᵣₑₗ is the relative velocity and is equivalent to zero since a distance between both frames is constant (defined by gear dimensions). Considering the system and referring to FIG. 18, \vec{V}₀ can be written as:

$${\vec{V}}_{0} = \frac{d {\vec{R}}_{0}}{d t} = {\vec{ω}}_{c} \times {\vec{R}}_{0} \qquad ( 21 )$$

$$with :$$

$${\vec{ω}}_{c} = ‖ {ω}_{c} ‖ {\vec{u}}_{z} \qquad ( 22 )$$

$$and :$$

$${\vec{R}}_{0} = \frac{{D}_{p 2}}{2} cos {θ}_{c} {\vec{u}}_{x} + \frac{{D}_{p 2}}{2} sin {θ}_{c} {\vec{u}}_{y} \qquad ( 23 )$$

$$Thus :$$

$${\vec{V}}_{0} = ‖ {ω}_{c} ‖ ‖ {r}_{p 2} ‖ cos {θ}_{c} {\vec{u}}_{y} - ‖ {ω}_{c} ‖ ‖ {r}_{p 2} ‖ sin {θ}_{c} {\vec{u}}_{x} \qquad ( 24 )$$

Next, the third term of (20) can be determined by first defining:

$${\vec{ω}}_{p 2} = - ‖ {ω}_{p 2} ‖ {\vec{u}}_{z} \qquad ( 25 )$$

$$and$$

$${\vec{r}}_{s} = \frac{{D}_{p 2}}{2} cos {θ}_{p 2} {\vec{u}}_{x} + \frac{{D}_{p 2}}{2} sin {θ}_{p 2} {\vec{u}}_{y} \qquad ( 26 )$$

so that the last term in (20) is:

$${\vec{ω}}_{p 2} \times {\vec{r}}_{s} = ‖ {ω}_{p 2} ‖ ‖ {r}_{p 2} ‖ cos {θ}_{p 2} {\vec{u}}_{y} - ‖ {ω}_{p 2} ‖ ‖ {r}_{p 2} ‖ sin {θ}_{p 2} {\vec{u}}_{x} \qquad ( 27 )$$

Substituting (24) and (27) into (20), a general expression for FCR velocity is:

$$\vec{{V}_{s}} = ( - ‖ {ω}_{p 2} ‖ ‖ {r}_{p 2} ‖ sin {θ}_{p 2} - ‖ {ω}_{c} ‖ ‖ {r}_{p 2} ‖ sin {θ}_{c} ) {\vec{u}}_{x} + ( ‖ {ω}_{c} ‖ ‖ {r}_{p 2} ‖ cos {θ}_{c} - ‖ {ω}_{p 2} ‖ ‖ {r}_{p 2} ‖ cos {θ}_{p 2} ) {\vec{u}}_{y} \qquad ( 28 )$$

For this design and since a diameter of planet gear 2 can be half of a ring gear diameter, substitutions can be made (e.g., θₚ₂=−θ_{c} & ωₚ₂=−ω_{c}). Therefore a second part of (28) (e.g., a u_{y} direction part) can cancel and the velocity of the FCR includes just an x component:

$$\vec{{V}_{s}} = 2 {r}_{p 2} {ω}_{c} sin {θ}_{c} \qquad ( 29 )$$

By integrating (29), the position of the FCR can be described as:

$$S = 2 {r}_{p 2} cos {θ}_{c} \qquad ( 30 )$$

### EXAMPLES

A prototype version, such as a protype shown in FIG. 3, of a compliant exoskeleton design has been manufactured and characterized. Thigh and shank modules of the compliant exoskeleton design can be created out of lightweight hollow carbon fiber rods. Each module can include a few male-female rods that slide into each other and can be connected with an adjusting clamp so that a length of the rods can be adjusted for different users. A majority of structure parts with complicated topology can be 3D printed using Tough PLA (polylactic acid) 3D printing material. Compared to conventional PLA and ABS materials, the Tough PLA can have better mechanical properties, including higher impact strength, stiffness, and reduced brittleness. Whereas internal parts (e.g., gears, shafts, springs, etc.) of a variable stiffness mechanism can be made from steel to resist large spring forces resulting from high stiffnesses.

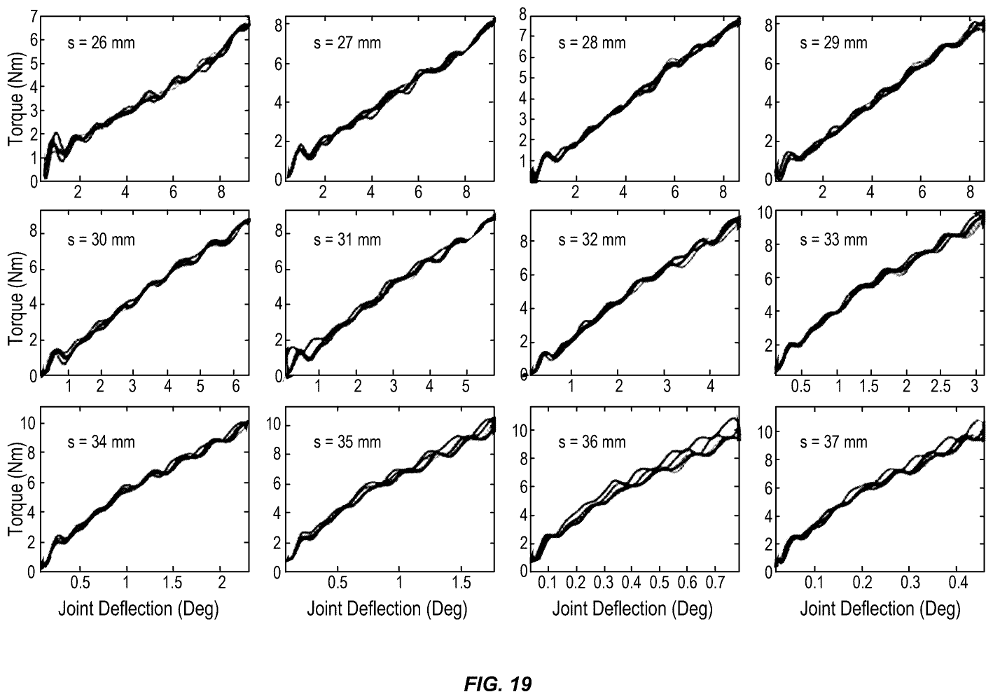

FIG. 18 is a schematic of an experimental setup for characterizing stiffness of a compliant knee exoskeleton according to certain aspects of the present disclosure. In the experimental setup, a thigh module (e.g., a support part) can be grounded (e.g., attached to a test bench). An extension spring can be attached to a shank module to allow the exoskeleton system to pivot around a knee joint. The experimental setup can permit a command of different position signals as an input to an external motor (e.g., external motor ml) while a load is exerted on the knee joint due to the extension spring without restricting joint motion. A ramp signal can be commanded to the motor, and an experiment can be repeated five times for each different FCR position to access repeatability of achieved stiffness values. Simultaneously, a torque exerted by the motor can be recorded along with a corresponding joint deflection for different pivot locations. FIG. 19 is a set of exemplary graphs of exerted torque (Tₑₓₜ) versus joint deflection (α) for various pivot positions s of a compliant knee exoskeleton according to certain aspects of the present disclosure. As joint stiffness can be defined by a variation of exerted torque with the corresponding joint deflection, achieved stiffness can be calculated by determining an average slope from the five different trials for each pivot location.

TABLE 2
shows experimental and theoretical values of joint stiffness.

| s (mm) | ${K}_{{α}_{e x}} \pm Avg \cdot Dev \cdot ( \frac{Nm}{rad} )$ | ${K}_{{α}_{th}} ( \frac{Nm}{rad} )$ |
|---|---|---|
| 26 | 28.9 ± 0.73 | 30.4 |
| 27 | 37.1 ± 0.53 | 36.6 |
| 28 | 40 ± 1 | 44.6 |
| 29 | 41.5 ± 0.9 | 55.1 |
| 30 | 60 ± 1.5 | 69.2 |
| 31 | 66.6 ± 1.8 | 88.5 |
| 32 | 89.2 ± 1 | 116.2 |
| 33 | 128.8 ± 2.9 | 157.7 |
| 34 | 186.4 ± 2.8 | 223.8 |
| 35 | 291.3 ± 13.4 | 338.7 |
| 36 | 505.7 ± 25 | 566.7 |

Table 2 reports joint stiffness values acquired both experimentally and theoretically (using equation (3)), along with calculated average deviations calculated for repeated experiments. For the experimental values, data was collected for FCR locations between a range of 26 mm and 36 mm with 1 mm increment. The range can represent an effective stiffness range region of an optimization process. A small stiffness change can be noticed within a first six entries for s in Table 2. For larger position values (e.g., s>31 mm), an exponential growth in stiffness values can occur. A target stiffness range (e.g., 30-500 Nm/rad) can be achieved by driving a FCR pivot from 26 mm to 36 mm. Such a change in pivot position can be executed in 0.2 seconds.

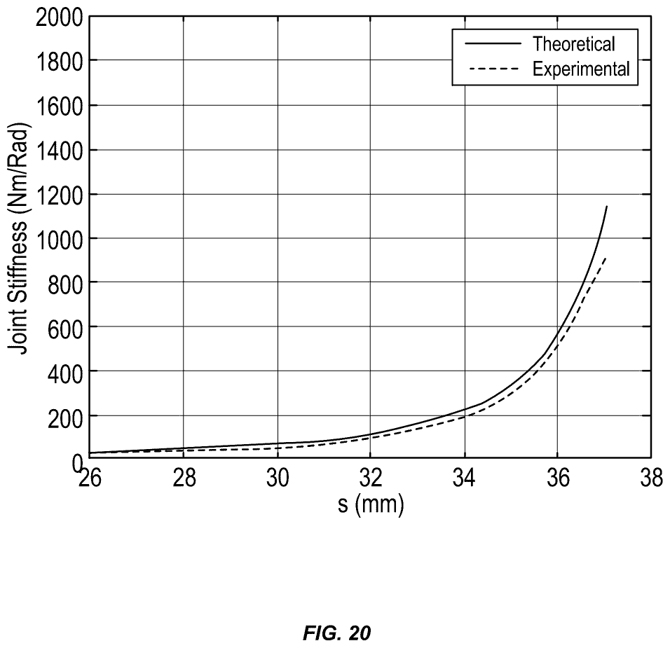

FIG. 20 is a graph that illustrates corresponding joint stiffnesses of different positions for a compliant knee exoskeleton according to certain aspects of the present disclosure. Values in FIG. 20 can represent joint stiffness that can be achieved when a FCR moves between positions from 26 mm and 37 mm from a rotation center for a joint. When s is below 26 mm, exhibited joint stiffness can be very small and almost constant throughout a range for s. Alternatively, when the FCR moves further away from the rotation center and closer to a spring base cylinder (s>37 mm), the joint stiffness can become extremely large (e.g., almost rigid). Since a selection of main physical design parameters can be made based on an optimization framework and specifically for knee exoskeletons, a achieved stiffness range for a compliant exoskeleton can represent a target range of stiffness (e.g., approximately 30 Nm/rad-500 Nm/rad).

| Parameter | Target | Achievement |
|---|---|---|
| Degrees of Freedom (DoF) | One actuated DoF for knee | One actuated DoF for knee |
| | flexion/extension motion | flexion/extension motion |
| Range of Motion (RoM) | 10°-60° | −135°-135° (to adapt |
| | | to both right and left legs) |
| Maximum continuous torque | 40 Nm (rated) | 48 Nm (rated) |
| Weight (without batteries) | <3 Kg | 3.4 Kg |
| Maximum joint rotational | 50 rpm | 57 rpm at rated torque |
| speed | | (48 Nm) |
| Size | Adjustable for multiple | Adjustable for body heights |
| | user hrights | between 152 cm to 195 cm |
| | | (e.g., from 5^{th} percentile |
| | | female to 95^{th} percentile |
| | | male) |
| Stiffness range | 30 Nm/rad to 450 Nm/rad | 30 Nm/rad to 500 Nm/rad |
| Stiffness change time | 0.2-0.3 sec over target | 0.2 sec over target range |
| | range | |

Table 3 shows target values of compliant exoskeleton parameters in comparison to achieved values by a prototype of the compliant exoskeleton.

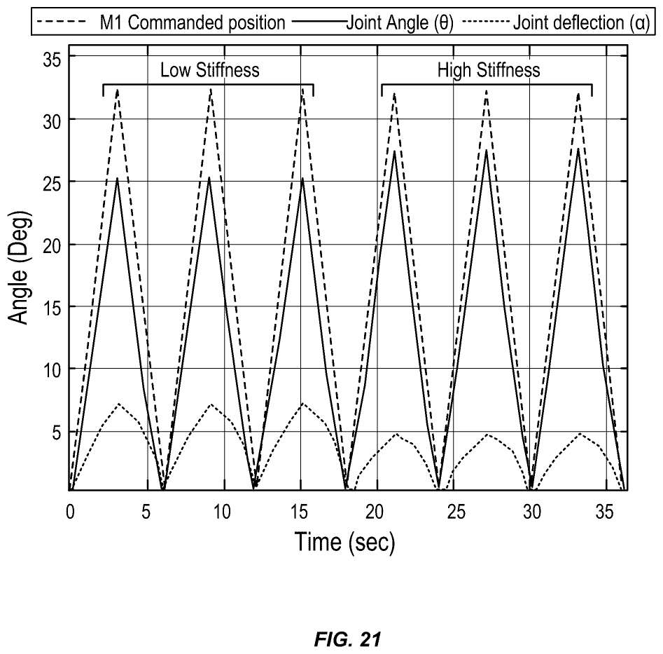

The compliant knee exoskeleton joint can follow a concept of changing a transmission ratio between a spring and an output. In such compliant mechanisms, an effect of changing stiffness can appear in a presence of an external force (e.g., with an external torque) applied on the joint. To study a relationship that governs all joint angles for the knee exoskeleton system, a periodic (increasing-decreasing) ramp signal can be commanded for two different stiffness values (e.g., a high stiffness value and a low stiffness value) using an experimental set-up, such as the experimental set-up depicted in FIG. 18. FIG. 21 is a graph depicting a time dependence for various angles associated with a compliant knee exoskeleton according to certain aspects of the present disclosure. FIG. 21 can illustrate corresponding joint angles when a similar external load is applied to the joint. A joint rotation angle θ can be measured using an external rotatory encoder, while a motor-controlled position can be measured using an embedded absolute encoder of the external motor (e.g., motor m1). An angle (θₘ₁) commanded to the external motor can represent a combination of the joint rotational angle θ and a joint deflection angle α, which can be coupled through a pivot location responsible for changing stiffness. The angles can be related as: θ=θₘ₁−α. If no external load is applied to the joint, torsional springs may not be deflected and thus the joint deflection angle can be zero (e.g., θ=θₘ₁).

The compliant knee exoskeleton prototype can be considered as two systems working in synchronization together. A first system can be responsible for changing stiffness, and can be driven by an internal servomotor. Whereas a second or main system can be a knee exoskeleton, which can be driven by an external motor and can be responsible for driving a knee joint along desired trajectories (e.g., target positions, velocities, or torques). In the following section, a developed control system developed for the compliant knee exoskeleton is summarized.

### Knee Exoskeleton Control System

For the knee exoskeleton prototype, a low-level controller was developed to highlight a prototype ability to follow a desired stiffness trajectory during gait. Healthy knee joint kinematics can be used to define input trajectories for the low-level controller. Target stiffness values can be mapped to stiffness characterization results (such as results highlighted in FIG. 20) and to a kinematic model of a compliant mechanism to estimate corresponding s and θₘ₂ values as an input to an internal motor. A target knee joint angle trajectory can be predetermined with a predefined input (e.g., θₘ₁) for the external motor. Position trajectory control can be implemented for both the external and internal motors where proportional-integral-derivative (PID) control gains can be tuned to accurately follow the target trajectories.

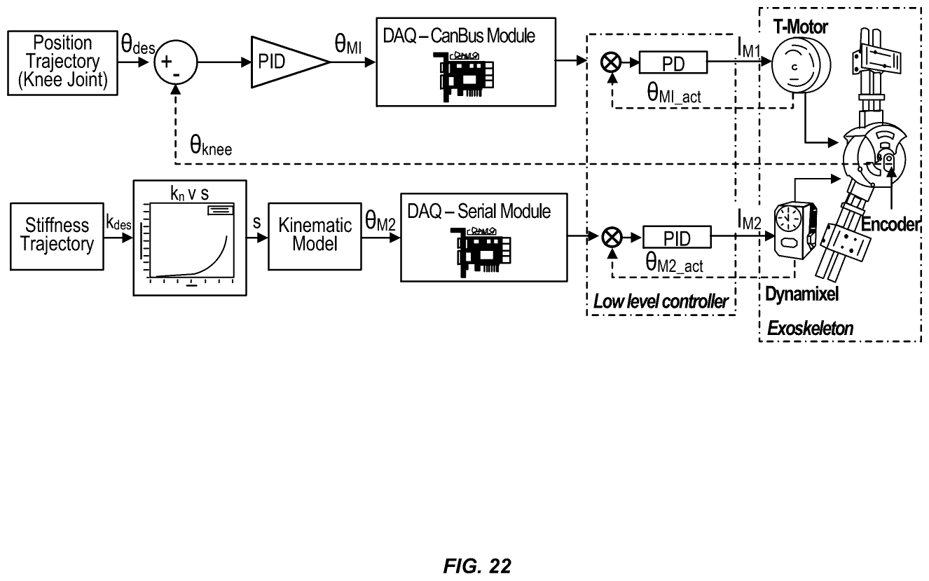

FIG. 22 is a schematic diagram of system architecture and a controller block diagram for a compliant knee exoskeleton according to certain aspects of the present disclosure. All electronic components of a knee exoskeleton system can be communicated through a real-time controller (e.g., a Quanser controller). Hardware can include a host computer and a target computer that both communicate with a 100 MBps communication speed. An external motor (e.g., m1) can be communicated through a can-bus interface, while an internal motor can be communicated through a serial protocol/TTL. A rotary encoder can be attached to an outer surface of the exoskeleton and interfaced using a Q8-USB data acquisition device (DAQ) to measure an output/knee angle θ. A controller model for all of the electronic components can be implemented using a Matlab/Simulink environment on the host computer. Thus, full synchronization between both motor motions can be achieved.

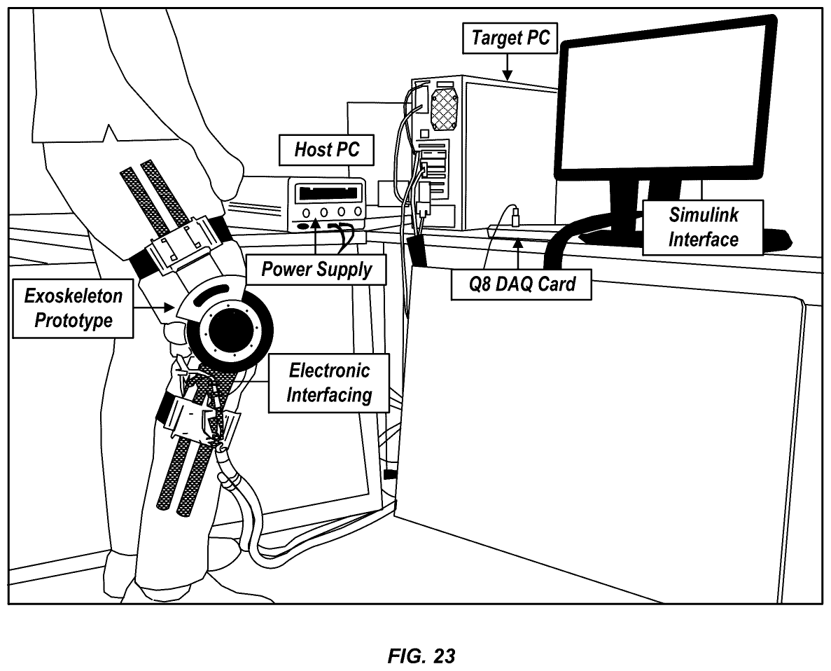

FIG. 23 is an hardware setup highlighting components associated with a compliant knee exoskeleton according to certain aspects of the present disclosure. The experimental setup can be used to validate an ability of the compliant exoskeleton system to follow target stiffness and target knee joint angle trajectories. The experiment can be conducted on a healthy human subject. A subject can walk on a treadmill while wearing the compliant exoskeleton with most weight of the subject supported using treadmill handles. Experiments can be using the experimental setup that mimic a basic rehabilitation activity, where the exoskeleton can drive a leg of a person along target trajectories while walking.

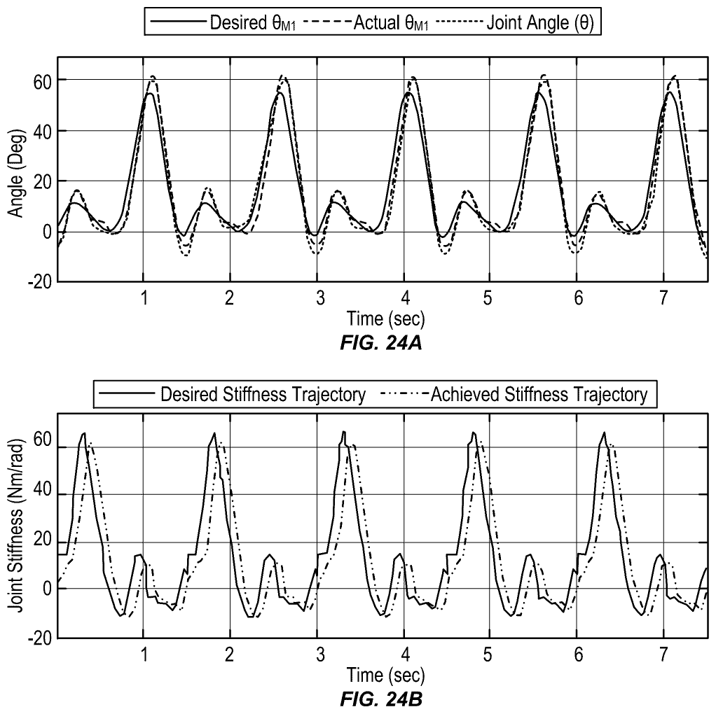

FIGS. 24A and 24B are exemplary graphs depicting a compliant knee exoskeleton ability to track target joint kinematics and stiffness data according to certain aspects of the present disclosure. To achieve data depicted in FIGS. 24A and 24B, only a weight of a shank module may be acting as a load on a knee joint. FIG. 24A depicts target input angle along with an achieved joint position. FIG. 24B illustrates an ability of the knee exoskeleton system to follow target stiffness trajectories for the knee joint. Both FIGS. 24A and 24B illustrate results for five consecutive gait cycles, with a gait cycle time of 1.5 seconds.

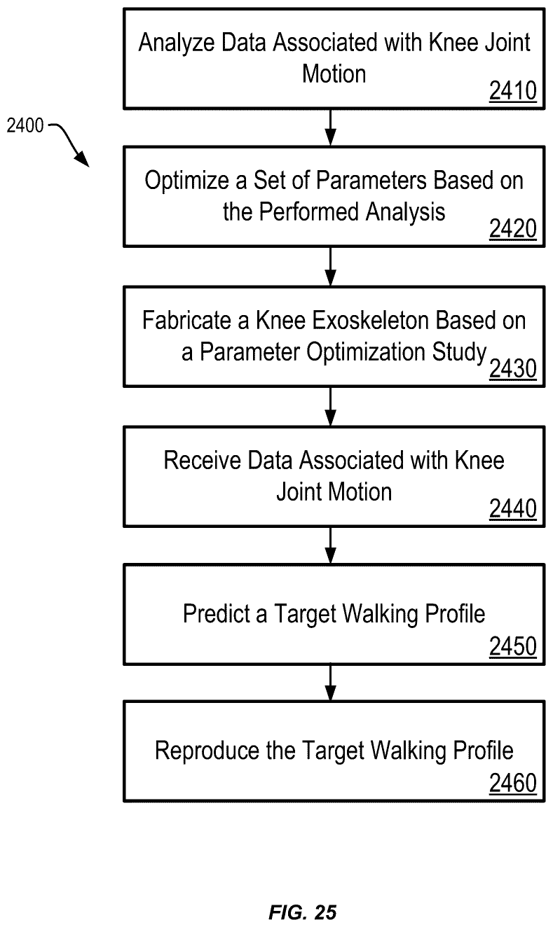

FIG. 25 is a flow chart of a process 2400 for designing, fabricating, and/or controlling a compliant knee exoskeleton according to certain aspects of the present disclosure. Operations of processes may be performed by software, firmware, hardware, or a combination thereof. Other examples can involve more operations, fewer operations, different operations, or a different order of operations than shown in FIG. 24. The operations of the process 2400 can begin at block 2410.

At block 2410, the process 2400 involves analyzing data associated with knee joint motion. The data can be compiled data describing parameters associated with a healthy knee joint performing a variety of tasks, such as sitting, walking, climbing stairs, running, lifting, etc. In some examples, the data can be received from sensors connected to a human subject. For example, the human subject can be scheduled for a knee operation that may involve knee rehabilitation post-surgery. The sensors can be connected to the subject to monitor characteristics of a knee while performing operations. At block 2420, the process involves optimizing a set of parameters based on the performed analysis. A parameter optimization study can be executed to determine design parameters for the knee exoskeleton. For example, constraints for the parameter optimization study can be based on the walking profile. The design parameters can include optimized parameters from the parameter optimization study selected to ensure that the knee exoskeleton can perform characteristics of the walking profile without straining components of the knee exoskeleton. Examples of the optimized parameters in the parameter optimization study can include stiffness of torsional springs within a VSA, diameters of a pivot cylinder for a force contact roller, or a diameter of a spring base cylinder.

At block 2430, the process 2400 involves fabricating the compliant knee exoskeleton based on the parameter optimization study. The fabricated compliant knee exoskeleton can include one or more optimized parameters determined from the parameter optimization study. The one or more parameters can include the stiffness of torsional springs within the VSA, diameters of the pivot cylinder for the force contact roller, or the diameter of the spring base cylinder.

At block 2440, the process involves receiving data associated with knee joint motion. At block 2450, the process 2400 involves predicting a walking profile. The walking profile can be, for example, a plot of knee joint stiffness versus time during a task. The walking profile can be used to determine target parameters, such as a range joint stiffnesses, a target joint stiffness change rate, a target knee joint stiffness behavior, etc., of for a compliant knee exoskeleton. In some examples, the walking profile can involve tasks besides walking such as taking a seat, standing up, climbing inclines, etc.

At block 2460, the process 2400 involves reproducing the walking profile using the knee exoskeleton. Reproducing the walking profile can involve adjusting, continuously, a stiffness value of a VSA system of the knee exoskeleton based on a portion of the target walking profile. Adjusting the stiffness value can involve adjusting an elastic transmission between a set of elastic elements and an output part of the VSA system. The stiffness value can be adjusted, for instance, to match a joint stiffness time dependence determined from the walking profile. A stiffness range of the VSA can match a stiffness range described in the walking profile. The stiffness range can include a minimum and maximum stiffness value. In some examples, the stiffness value can be changed from the minimum stiffness value to the maximum stiffness value and vice versa in 0.2 seconds. Adjusting the stiffness can involve varying a location of a position of contact between a force contact roller and a set of elastic elements within the VSA system.

Reproducing the walking profile can involve receiving and monitoring data received from sensors attached to components of the knee exoskeleton or to human limbs. The sensors can be encoders, electromyography (EMG) sensors, or inertial measurement unit (IMU) sensors. In some examples, a plot of joint stiffness for the knee exoskeleton versus time can be plotted in real time and compared to a target plot, such as the walking profile. Adjustments to the stiffness value of the VSA can be modified based on a comparison between the real time plot of knee exoskeleton joint stiffness and the walking profile, which can define a target joint stiffness time dependence. The comparison can involve, for each data point, determining a difference between the real time plot and the target plot. The adjustments can be based on minimizing the difference. Reproducing the walking profile can further include driving, in synchronization with the stiffness value adjustment, at least one joint.

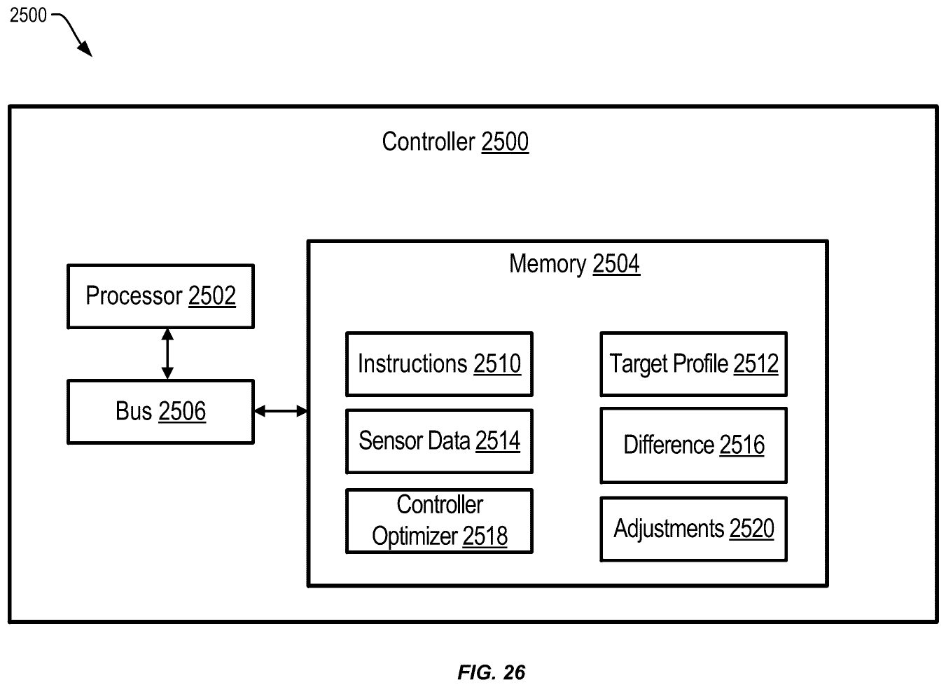

FIG. 26 is a block diagram of a controller 2500 for a compliant knee exoskeleton according to certain aspects of the present disclosure. The controller 2500 can be an intelligent controller. As shown, the controller 2500 includes a processor 2502 communicatively coupled to memory 2504. The processor 2502 can include one processing device or multiple processing devices. Non-limiting examples of the processor 2502 include a Field-Programmable Gate Array (FPGA), an application specific integrated circuit (ASIC), a microprocessor, or any combination of these. The processor 2502 can execute instructions 2510 stored in the memory 2504 to perform operations, such as the operations of process 2400 from FIG. 25. In some examples, the instructions 2510 can include processor-specific instructions generated by a compiler or an interpreter from code written in any suitable computer-programming language, such as C, C++, C#, Python, or Java.

The memory 2504 can include one memory device or multiple memory devices. The memory 2504 can be non-volatile and may include any type of memory device that retains stored information when powered off. Non-limiting examples of the memory 2504 include electrically erasable and programmable read-only memory (EEPROM), flash memory, or any other type of non-volatile memory. At least some of the memory 2504 can include a non-transitory computer-readable medium from which the processor 2502 can read instructions 2510. The non-transitory computer-readable medium can include electronic, optical, magnetic, or other storage devices capable of providing the processor 2502 with the instructions 2510 or other program code. Non-limiting examples of the non-transitory computer-readable medium include magnetic disk(s), memory chip(s), RAM, an ASIC, or any other medium from which a computer processor can read instructions 2510.

The memory 2504 can further include a target profile 2512, sensor data 2514, a difference 2516, a controller optimizer 2518, and adjustments 2520. The target profile 2512 can be a walking profile based on characteristics of a human joint, such as a knee joint, while performing a task, such as walking, sitting, standing, climbing stairs, etc. The target profile 2512 can be a time dependence of knee joint stiffness while performing the task.

The controller 2500 can receive and evaluate the sensor data 2514 from sensors deployed on or near components of the exoskeleton. Parameters that can be monitored based on the sensor data 2514 can include joint positions, joint velocities, joint deflections, overall joint stiffness, time measurements, forces, torques, VSA component positions and velocities, etc. In some examples, the sensor data 2514 can be received and evaluated in real time. Real-time can mean as sensors record and transmit data. The sensor data 2514 can be used to create and evaluate a graph of an overall joint stiffness profile with time for the exoskeleton. In some examples the graph can be a real-time graph. The adjustments 2520 can be determined based on the sensor data 2514. The difference 2516 can be a difference between the graph and the target profile 2512. In some examples, the adjustments 2520 can be based on the difference 2516. The controller optimizer 2518 can apply the adjustments 2520 and alter operations of the exoskeleton. Examples of parameters that can be adjusted can include joint stiffness, joint position, joint torque, etc.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. An exoskeleton system comprising:
a plurality of modules;
at least one joint configured to connect a thigh module to a shank module of the plurality of modules; and
a variable stiffness actuator (VSA) system comprising a VSA, the VSA system coupled with each of the thigh module and the shank module and configured to drive the plurality of modules.

2. The exoskeleton system of claim 1, wherein the VSA is configured to cover a range of stiffnesses and stiffness change rates consistent with that of an average human knee.

3. The exoskeleton system of claim 2, wherein the range of stiffnesses comprises a minimum stiffness value of
$$30 \frac{Newtons \cdot meter ( N \cdot m )}{radian ( rad )}$$
and a maximum stiffness value of
$$500 \frac{N \cdot m}{rad} .$$

4. The exoskeleton system of claim 3, wherein the VSA is further configured to change stiffness from a maximum stiffness value to a minimum stiffness value in less than one second.

5. The exoskeleton system of claim 1, comprising:
an output part configured to transfer motion to a human limb;
a support part configured to support an input part; and
the input part configured to transfer kinetic energy for the output part, the input part comprising:
a set of elastic elements mounted on the output part; and
a stiffness adjustor configured to adjust an elastic transmission between at least one elastic element of the set of elastic elements and the output part.

6. The exoskeleton system of claim 5, wherein the set of elastic elements comprises at least one torsional spring.

7. The exoskeleton system of claim 6, wherein the stiffness adjustor comprises a force contact roller and wherein a stiffness of the VSA is adjusted by varying a location of a position of contact between the force contact roller and the set of elastic elements.

8. The exoskeleton system of claim 7, wherein parameters of the at least one torsional spring or the force contact roller are optimized to follow a stiffness trajectory of a knee joint.

9. The exoskeleton system of claim 8, wherein the parameters comprise stiffness of the at least one torsional spring, diameters of a pivot cylinder for the force contact roller, or a diameter of a spring base cylinder.

10. The exoskeleton system of claim 5, further comprising:
an internal motor configured to adjust a stiffness of the VSA by controlling a position of the stiffness adjustor;
an external motor configured to drive the at least one joint; and
a controller configured to synchronize the internal motor with the external motor.

11. The exoskeleton system of claim 1, further comprising:
a plurality of sensors; and
an intelligent controller configured to communicate with the plurality of sensors and to predict a target walking profile based on data received from the plurality of sensors.

12. The exoskeleton system of claim 11, wherein the plurality of sensors comprises encoders, electromyography (EMG) sensors, or inertial measurement unit (IMU) sensors.

13. The exoskeleton system of claim 1, wherein the exoskeleton system is optimized to mimic a stiffness trajectory of a human knee joint during gait.

14. A method for controlling an exoskeleton, the method comprising:
receiving data associated with knee joint motion;
predicting a target walking profile based on the data;
reproducing the target walking profile by:
adjusting, continuously, a stiffness value of a variable stiffness actuator (VSA) system based on a portion of the target walking profile; and
driving, in synchronization with stiffness value adjustment, at least one joint.

15. The method of claim 14, wherein the data is received from a plurality of sensors.

16. The method of claim 15, the plurality of sensors comprises encoders, electromyography (EMG) sensors, or inertial measurement unit (IMU) sensors.

17. The method of claim 14, wherein adjusting the stiffness value of the VSA comprises adjusting the stiffness by varying a location of a position of contact between a force contact roller and a set of elastic elements.

18. A method for fabricating an exoskeleton, the method comprising:
analyzing data associated with knee joint motion;
optimizing a set of parameters based on the performed analysis; and
fabricating the exoskeleton based on a parameter optimization study.

19. The method of claim 18, further comprising selecting values for parameters based on the parameter optimization study to perform characteristics of the walking profile without straining components of the knee exoskeleton.

20. The method of claim 19, wherein the parameters comprise stiffness of the at least one torsional spring, diameters of a pivot cylinder for the force contact roller, or a diameter of a spring base cylinder.
